(19) United States
(12) Patent Application Publication
(10) Pub. No.: US 2026/0320115 A1
(43) Pub. Date: Oct. 15, 2026

(54) INFORMATION PROCESSING APPARATUS, SYSTEM, AND INFORMATION PROCESSING METHOD

(71) Applicant: Tatsuma HIROKAWA, Kanagawa (JP)

(72) Inventor: Tatsuma HIROKAWA, Kanagawa (JP)

(21) Appl. No.: 19/637,106

(22) Filed: Apr. 2, 2026

(30) Foreign Application Priority Data
Apr. 14, 2025 (JP) 2025-066433

(51) Int. Cl. G06F 16/583; G06F 3/0482; G06F 3/0484; G06V 10/70; G06V 10/94; G06V 30/19

(52) U.S. Cl. CPC G06F 16/583; G06F 3/0482; G06F 3/0484; G06V 10/70; G06V 10/95; G06V 30/19

(57) ABSTRACT

An information processing apparatus communicably connected to a server apparatus and a generative AI system, includes circuity that: receives input of an image from which information to be registered in the server apparatus is extracted; transmits, to the generative AI system, the image and a request to extract information from the image, the information corresponding to an item set in advance; receives, from the generative AI system, the information corresponding to the item and extracted from the image by the generative AI system; and transmits, to the server apparatus, the information corresponding to the item to register the information in the server apparatus.

### CROSS-REFERENCE TO RELATED APPLICATIONS

This patent application is based on and claims priority pursuant to 35 U.S.C. § 119(a) to Japanese Patent Application No. 2025-066433, filed on Apr. 14, 2025, in the Japan Patent Office, the entire disclosure of which is hereby incorporated by reference herein.

### BACKGROUND

### Technical Field

The present disclosure relates to an information processing apparatus, a system, and an information processing method.

### Related Art

There are techniques for analyzing image data using artificial intelligence (AI) and outputting an analysis result. Information processing apparatuses equipped with AI have abilities to output an object or scene depicted in image data, classify image data, and detect an abnormality in image data, for example.

There is a technique of extracting information such as a person's name or a company name from image data of business cards and registering the extracted information in a server.

This technique uses a logic for extracting information from image data, for example, a logic for extracting a name such as a person's name or a company name from image data of business cards. However, such a logic is to be prepared in advance. For example, when a business card management application uses optical character reader/recognition (OCR) to recognize a character string, a logic for determining whether the character string is a person's name or a company name is to be programmed by a developer in advance.

### SUMMARY

The present disclosure described herein provides an information processing apparatus communicably connected to a server apparatus and a generative AI system. The information processing apparatus includes circuitry that receives input of an image from which information to be registered in the server apparatus is extracted; transmits, to the generative AI system, the image and a request to extract information from the image, the information corresponding to an item set in advance; receives, from the generative AI system, the information corresponding to the item and extracted from the image by the generative AI system; and transmits, to the server apparatus, the information corresponding to the item to register the information in the server apparatus.

The present disclosure described herein provides a system including an information processing apparatus and a server apparatus communicably connected to the information processing apparatus and a generative AI system. The information processing apparatus includes apparatus circuitry that receives input of an image from which information to be registered in the server apparatus is extracted; transmits, to the generative AI system, the image and a request to extract information from the image, the information corresponding to an item set in advance; receives, from the generative AI system, the information corresponding to the item and extracted from the image by the generative AI system; and transmits the information corresponding to the item to the server apparatus to register the information in the server apparatus. The server apparatus includes server circuitry that receives input of an image from which information to be registered in the server apparatus is extracted; transmits, to the generative AI system, the image and a request to extract information from the image, the information corresponding to an item set in advance; receives, from the generative AI system, the information corresponding to the item and extracted from the image by the generative AI system; and registers the received information in association with the item.

The present disclosure described herein provides an information processing method performed by an information processing apparatus communicably connected to a server apparatus and a generative AI system. The information processing method includes receiving input of an image from which information to be registered in the server apparatus is extracted; transmitting, to the generative AI system, the image and a request to extract information from the image, the information corresponding to an item set in advance; receiving, from the generative AI system, the information corresponding to the item and extracted from the image by the generative AI system; and transmitting the information corresponding to the item to the server apparatus to register the information in the server apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an application setting screen displayed by a user terminal;

FIG. 2 is a diagram illustrating an example of an input screen of a business card management application displayed by a user terminal;

FIG. 3 is a diagram illustrating an example of a procedure in which a user inputs values for input items of a business card management application;

FIG. 4 is a diagram illustrating an example of a procedure of an information setting service provided by an information processing system;

FIG. 5 is a diagram illustrating an example of a system configuration of an information processing system;

FIG. 6 is a diagram illustrating an example of a hardware configuration of an application service, a user terminal, and a developer terminal;

FIG. 7 is a diagram illustrating an example of a functional configuration of an application service and a user terminal;

FIG. 8 is a diagram illustrating an example of information set for input items of an application;

FIG. 9 is a diagram illustrating an example of information related to input items of an application;

FIG. 10 is a sequence diagram illustrating an example of a process performed by an information processing system;

FIG. 11 is a diagram illustrating parameters included in a request message transmitted by a user terminal to a generative AI system in step S6 in FIG. 10;

FIG. 12 is a diagram illustrating a prompt set in a “prompt” in FIG. 11;

FIG. 13 is a diagram illustrating a format of a response message transmitted by a generative AI system to a user terminal in step S7 in FIG. 10;

FIG. 14 is a diagram illustrating screen transition of an example of an input screen of a business card management application displayed by a user terminal;

FIG. 15 is a diagram illustrating screen transition of an example of an input screen of a business card management application displayed by a user terminal;

FIG. 16 is a diagram illustrating an example of a prompt generated by a request generation unit;

FIG. 17 is a diagram illustrating a response message from a generative AI system in response to a request message including the prompt illustrated in FIG. 16;

FIG. 18 is a diagram illustrating a modified example of screen transition of an input screen of a business card management application displayed by a user terminal;

FIG. 19 is a diagram illustrating a modified example of screen transition of an input screen of a business card management application displayed by a user terminal;

FIG. 20 is a diagram illustrating a modified example of screen transition of an input screen of a business card management application displayed by a user terminal;

FIG. 21 is a diagram illustrating an example of a method for setting values for input items using a function call capability;

FIG. 22 is a diagram illustrating an example of a request message including arguments of a function;

FIG. 23 is a diagram illustrating an example of a response message from a generative AI system when the generative AI system has a function call capability;

FIG. 24 is a diagram illustrating an example of a process in which an information processing system sets values to an application service;

FIG. 25 is a diagram illustrating an example of a functional configuration of an application service and a user terminal;

FIG. 26 is a sequence diagram illustrating an example of a process performed by an information processing system;

FIG. 27 is a diagram illustrating an example of a method for setting values for input items using a function call capability;

FIG. 28 is a diagram illustrating an example of an image data selection screen displayed as a portion of or a pop-up window over an input screen of a business card management application;

FIG. 29 is a diagram illustrating an example of information related to input items having an input range;

FIG. 30 is a diagram illustrating an example of a prompt requesting values of input items in a JavaScript® Object Notation (JSON) format;

FIG. 31 is a diagram illustrating an example of a request message used when a generative AI system has a function call capability;

FIG. 32 is a diagram illustrating an example of a prompt using few-shot prompting;

FIG. 33 is a sequence diagram illustrating a modified example of a process performed by an information processing system when few-shot prompting is used and corresponding to the process in FIG. 10;

FIG. 34 is a sequence diagram illustrating a modified example of a process performed by an information processing system when few-shot prompting is used and corresponding to the process in FIG. 26;

FIG. 35 is a diagram illustrating an example of a request message transmitted by a user terminal to a generative AI system; and

FIG. 36 is a diagram illustrating an example of a character string set in a “prompt” in FIG. 35.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system according to embodiments of the present disclosure will be described below.

### Application Service

An application service is a service for assisting a user in creating applications in a low-code or no-code manner. Such a service is also called visual programming. The application service transmits a web application for assisting in creating applications to a user terminal operated by the user. This allows the user to operate the web application executed on the user terminal to create various applications.

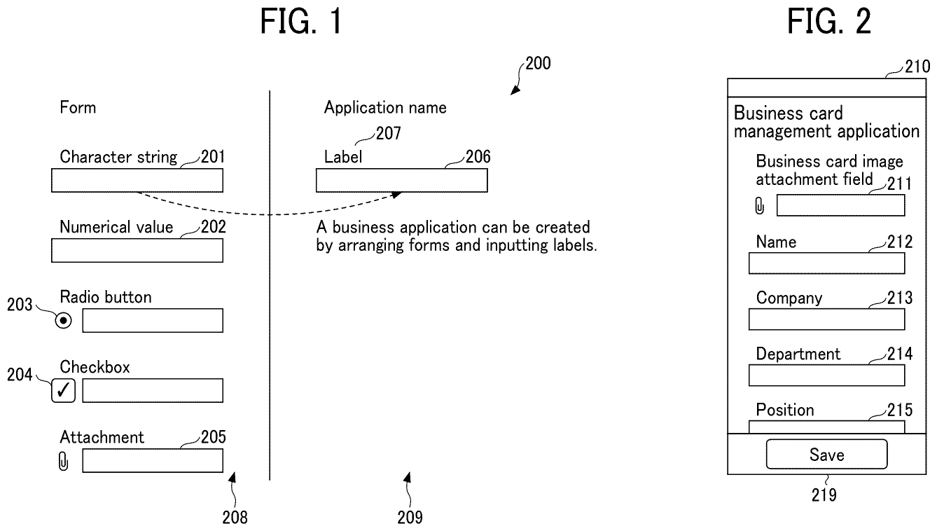

FIG. 1 illustrates an application setting screen 200 displayed by the user terminal. For example, the application setting screen 200 includes a form area 208 and a work area 209. The form area 208 displays a list of forms to be arranged in an application. The forms are display components of a screen. Examples of the forms include a text input form, a selection form, and a file registration form. FIG. 1 illustrates a character string form 201, a numerical value form 202, a radio button form 203, a checkbox form 204, and an attachment form 205. The aforementioned forms are merely examples.

The character string form 201 is a form for inputting a character string. For example, full-width characters, half-width characters, numerical values, and symbols can be input to the character string form 201.

The numerical value form 202 is a form for inputting a numerical value. Only numerical values can be input to the numerical value form 202.

The radio button form 203 is a form for a button that receives selection of one option from among a plurality of options. The radio button form 203 has a field to display an option.

The checkbox form 204 is a form for a checkbox that receives selection of one or more options from among a plurality of options. The checkbox form 204 has a field to display an option.

The attachment form 205 is a form that receives a setting of a file to be registered to the application. The attachment form 205 may have a restriction on the format of a file to be received for registration.

The work area 209 is an area in which the user arranges forms. The user operates a mouse pointer to drag and drop a form in the form area 208 to the work area 209. Alternatively, the user operates a touch panel with their finger or stylus to drag and drop a form to the work area 209.

A form arranged in the work area 209 is referred to as an input item 206. The input item 206 has one or more input fields. For simplicity, the input field may be simply referred to as an “input item” below.

For the input item 206, a label 207 can be displayed. The label 207 is an item name of the input item 206. The user inputs an appropriate label for the input item 206. The user repeats this operation to create any application. For example, the user arranges the character string forms 201 in the work area 209, and inputs labels such as “name” and “company”. In this manner, the user can create a business card management application described below. The position of the input item 206 already arranged in the work area 209 is changeable.

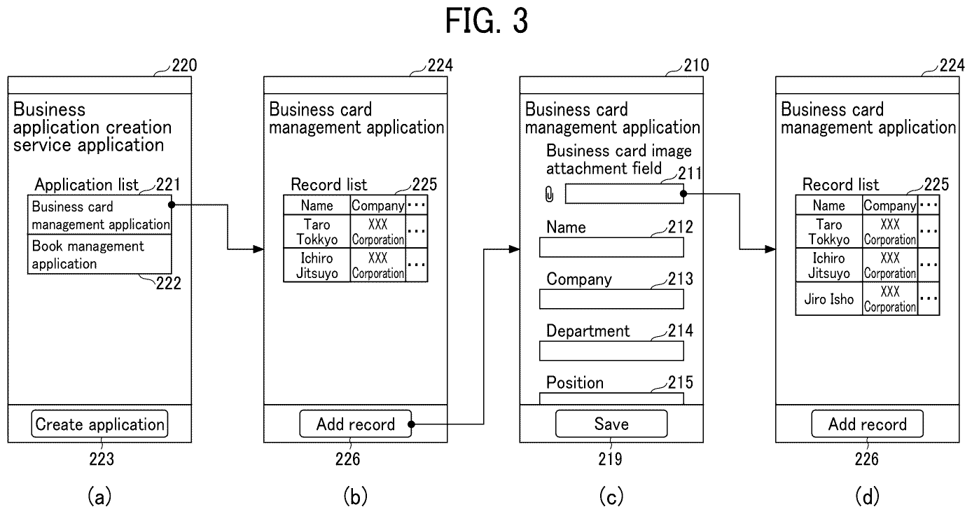

FIG. 2 illustrates an input screen 210 of a business card management application displayed by a user terminal. The input screen 210 of the business card management application includes a business card image attachment field 211, a name field 212, a company field 213, a department field 214, and a position field 215. FIG. 2 merely illustrates some input items, and the input screen 210 may include an address field, a telephone number field, an email address field, and a uniform resource locator (URL) field.

The aforementioned input items are merely examples. The application thus created is available to users for business or personal use. For example, the business card management application allows users to input information written on a business card received from a customer to the corresponding input items. In this manner, the business card management application enables digitization of the information. Alternatively, the business card management application enables sharing of the business card information among a team.

FIG. 3 is a diagram illustrating a procedure in which a user inputs values for input items of a business card management application. FIG. 3(a) illustrates an application list 220 displayed by the user terminal operated by the user. The application list 220 is a list of applications created and registered in the application service by users in the procedure illustrated in FIG. 1. For example, the application list 220 displays a business card management application 221 and a book management application 222. The user selects the business card management application 221 in this case. Note that a create application button 223 is a button for displaying the screen illustrated in FIG. 1.

FIG. 3(b) illustrates a record list 224 displayed by the user terminal. The record list 224 displays, as a table, a list of records, where a single piece of business card information registered in the business card management application 221 is a single record. A record refers to data of one row when pieces of data in a database are arranged in a two-dimensional table. A single record corresponds to a single piece of business card information. A record 225 has a plurality of input items. These input items may be called fields. One vertical line of the table is referred to as a column. In FIG. 3(b), two records of business card information are registered.

When the user presses an add record button 226, the input screen 210 of the business card management application 221 is displayed. FIG. 3(c) illustrates the input screen 210 of the business card management application 221. As described above, the input screen 210 of the business card management application 221 includes the input items created by the user for the business card management application 221. The user inputs values for the respective input items, and presses a save button 219. The input content, which is the business card information in this case, is saved as a record in the application service.

FIG. 3(d) illustrates the record list 224 displayed by the user terminal. The business card information input on the input screen 210 of the business card management application 221 in FIG. 3(c) is displayed as one record. That is, three records in total are displayed.

As described above, since a keyboard is typically used for input to the input items, the workload of the user is large. In addition, a mistake may occur during the input.

### Process Procedures

Accordingly, in the present embodiment, the user terminal transmits, to a generative AI system, a file of image data of a business card input to the attachment form 205 and a list of input items of an application to request the generative AI system to generate values to be set for the input items. The generative AI system performs various natural language processing tasks, such as text generation, question answering, text classification, sentiment analysis, information extraction, and text summarization. An example of the generative AI system is Copilot® , which proposes code to be written next while the user is coding a program. In the present embodiment, a technique will be described in which the generative AI system extracts information from the image data without having a conversation, which may be referred to as a chat, with the user. The generative AI system or the functions of the generative AI system may be simply referred to as artificial intelligence (AI).

The generative AI system analyzes the image data and the list of input items, generates values to be input for the input items, and transmits the generated values to the user terminal. The generative AI system may be provided as a system different from a system that provides a service related to the application. The service related to the application and the generative AI system may be provided by the same provider. The user terminal sets the generated values to the application service. The use of the application service allows the user to create any applications used for their work as well as the business card management application. Thus, the information processing system according to the present embodiment generates a value appropriate for an input item of any application from image data, and sets the generated value for the input item in the application service.

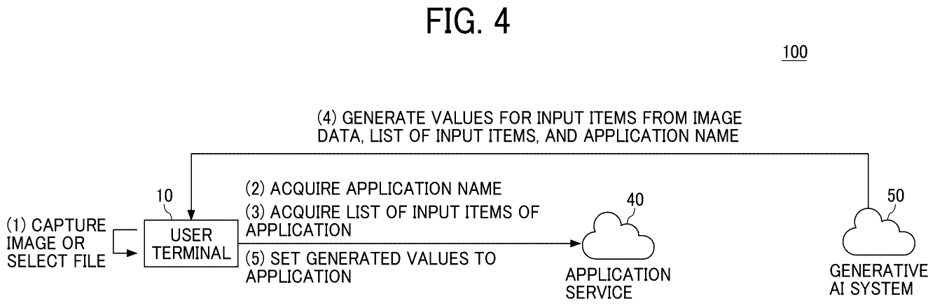

FIG. 4 is a diagram illustrating a process in which an information processing system 100 sets a value in an application service 40. A user terminal 10 executes a web application. An application having an input item to which a value is to be set has already been created in the application service 40. A generative AI system 50 analyzes image data of a business card and a list of input items of the application, and generates values to be set for the input items.
(1) A user captures an image of a business card with a camera built in or externally connected to the user terminal 10 to generate image data of the business card. Alternatively, the user designates a file storing image data of a business card on the user terminal 10. Both the captured image of the business card and the image of the business card stored in the file may be simply referred to as “image data” below.
(2) Triggered by an image-capturing operation or selection of a file, the user terminal 10 acquires an application name to be set as the value of the input item from the application service 40. In some embodiments, the application name may be omitted. In some embodiments, the user terminal 10 may acquire an explanation note of the application instead of the application name. The explanation note is an explanatory text of the application and set in advance by the user.
(3) The user terminal 10 also acquires, from the application service 40, a list of input items of the application. Note that the order of (2) and (3) may be changed. The user terminal 10 may simultaneously acquire the pieces of information in (2) and (3).
(4) The user terminal 10 transmits application-related information such as the list of input items, the image data, and the application name acquired in (1) to (3) to the generative AI system 50, and acquires values to be set for the input items. Specifically, the generative AI system 50 analyzes the image data, the list of input items, and the application name. The generative AI system 50 performs character recognition on the image data and generates a feature quantity indicating, for example, features of the image data to generate the values corresponding to the input items.
(5) The user terminal 10 transmits the values acquired from the generative AI system 50 to the application service 40 in association with the input items to set the values for the respective input items in the application service 40.

As described above, the information processing system 100 according to the present embodiment sets a value for an input item of any application.

### Terminology

An application is an abbreviation of an application program. In the present disclosure, an application is a program generated by a computer according to a certain task. An operating system (OS) is general-purpose software that provides basic functions and systems such as a file system, a communication system, and a display control system in operations performed by the computer. In contrast, the application provides specific functions while operating on the OS. Types of the application include a web application and a native application. In the present disclosure, either a web application or a native application may be developed.

An Application Programming Interface (API) is an interface for the application, namely, software, and functions as a contact point for connecting the systems to each other to share functions and mechanisms. The API defines the specification of an interface used by the applications to exchange information with each other. The API between the computers defines, for example, the specification for one web site to communicate with another web site by Hypertext Transfer Protocol (HTTP) or Hypertext Transfer Protocol Secure (HTTPS) communication. Through communication, the one web site may use the functions provided by the other web site. The API between the computers may be referred to as a web API.

For example, when the API transmits a specific request for data acquisition, update, deletion, or processing, the API returns a result such as data, an update result, a deletion result, or a processing result in response to the specific request. The request may be referred to as a request message, and the result may be referred to as a response message. Calling an API means transmitting a request and acquiring a result in accordance with the specification of the API. Calling an API may also be referred to as executing, operating, tapping, or using.

A user is an end user who uses an application provided by the application service 40. The user can also develop an application. A developer is a person who makes desired settings in the application service 40 in order to allow the development of an application by no-code or low-code programming and allow the use of the application.

An input item is an item having an input field for inputting information. In the input field, various kinds of information can be input. For example, image data, audio data, video data, a file, and information for selecting an option as well as a character string, a numerical value, and a symbol may be input.

Information corresponding to the input item is information to be set for the input field of the input item. The information corresponding to the input item is included in the image data, for example. For example, a generative AI system determines whether information is the information corresponding to the input item based on the label of the input item and a data format to extract the information corresponding to the input item from the image data.

A display unit is a functional unit that displays various types of information such as a cursor, a menu, a window, characters, or an image. For example, the display unit is implemented by a display described later.

### First Embodiment

### Example of System Configuration

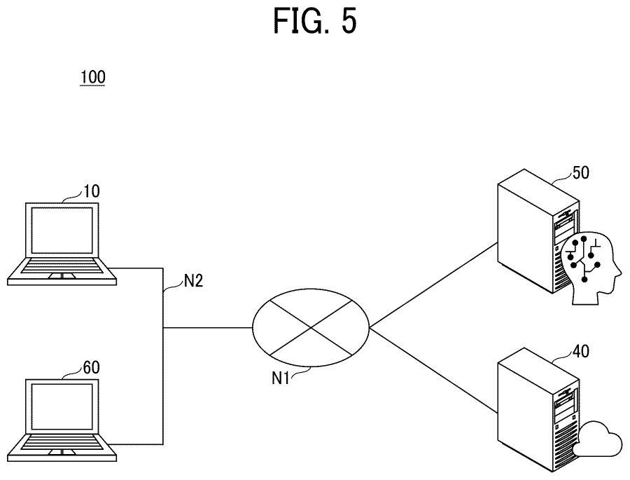

A system configuration of the information processing system 100 according to the present embodiment will be described with reference to FIG. 5. FIG. 5 is a diagram illustrating an example of the system configuration of the information processing system 100. The information processing system 100 illustrated in FIG. 5 includes the user terminal 10, a developer terminal 60, and the application service 40. The user terminal 10 and the developer terminal 60 are communicably connected to the application service 40 via networks N1 and N2. The information processing system 100 may further include the generative AI system 50. The user terminal 10 and the developer terminal 60 are communicably connected to the generative AI system 50 via the networks N1 and N2. The application service 40 may communicate with the generative AI system 50 via APIs.

The user terminal 10 and the developer terminal 60, which are installed at a facility such as a company or a home, are connected to the network N2. The network N2 may be a local area network (LAN), Wi-Fi®, wide-area Ethernet®, or a mobile phone network such as 4G, 5G, or 6G. The network N1 is a network for a wide area, such as Internet or a wide area network (WAN). The user terminal 10 and the developer terminal 60 are not necessarily connected to the network N2 all the time, and may be connected to the network N2 when using the generative AI system 50 or the application service 40.

The generative AI system 50 provides a service that allows a user to chat with AI in a natural language. An example of such a generative AI system 50 is a system that uses a large language model (LLM). The large language model is a model designed for natural language processing, which is trained using a large amount of text data. The generative AI system 50 receives a vast amount of text as input, and obtains knowledge from the input text by deep learning or reinforcement learning, for example. The generative AI system 50 uses this knowledge to provide a response message to a chat message. The chat message includes a prompt (described later) and image data. The prompt refers to text data in the chat message.

The generative AI system 50 that generates text in response to data based on the chat message may be referred to as generative AI. In the present embodiment, the response message returned by the generative AI system 50 is used to create a value of an input item of an application that operates on the application service 40. Types of the application that operates on the application service 40 include a web application that operates on the application service 40 and a native application that is installed on the user terminal 10. When the native application installed on the user terminal 10 is executed by the user terminal 10, the native application is connected to the application service 40 and executes the functions of the application service 40.

The generative AI system 50 has the following features.

First, the generative AI system 50 keeps the natural flow of conversation.

Second, the generative AI system 50 can make a proposal by expanding ideas even in the field in which the user has no knowledge.

Third, the generative AI system 50 can output accurate program codes.

Taking advantage of such features, the user provides the generative AI system 50 with the list of input items of the application and the image data, and thus can obtain values to be set for the input items from the generative AI system 50.

One of the three features is a function call capability, which may be referred to as “tool_call” or “function_call”. The present embodiment can be implemented in both a mode of using the function call capability and a mode of not using the function call capability. Since “tool_call” returned by the generative AI system 50 is accurate, in other words, highly reproducible, “tool_call” increases the possibility of obtaining the values for the input items in the JSON format.

Examples of the generative AI system 50 include systems that use an LLM such as GPT-3®, GPT-4®, Transformer®, and BERT® . In an example, the information processing system 100 according to the present embodiment can use ChatGPT® that uses GPT-3® or GPT-4® but may use a system that uses any other LLM.

The application service 40 is one or more information processing apparatuses that provide an application to be executed by the user. The application service 40 is a server apparatus that provides an application for managing information input by the user to input fields of input items. The application provided by the application service 40 is, for example, a database-based web application that manages data in a table format. The user can create any input items of the application and customize the application to save, read, or process data related to their work.

The user terminal 10 transmits the application-related information to the generative AI system 50, and thus receives a response message, specifically, input items and values for the input items, from the generative AI system 50. The user terminal 10 transmits the input items and the values for the input items to the application service 40. Thus, the user can automatically set information, which is supposed to be manually input, to the application from the image data.

Examples of the application service 40 include a cloud service, an application service provider (ASP), and Software as a Service (SaaS), and may include various services to be provided via a network. Examples of the service to be provided include a database providing service and a storage service. The application service 40 may be on the Internet or on premises.

The functions of the application service 40 may be distributed to a plurality of information processing apparatuses. A plurality of application services 40 having the same functions may be present, and the number of application services 40 may be changed in accordance with the processing load.

A web server may be present separately from the application service 40, and the web server may communicate with the user terminal 10. In this case, the user terminal 10 communicates with the generative AI system 50 as in the above-described case, but the web server communicates with the application service 40 on behalf of the user terminal 10.

The server is a computer or software having a function of providing information or a processing result in response to a request from a client.

The application service 40 receives various settings from the developer terminal 60. The various settings include registration of a user to the application service 40 and registration of a web application for creating a chat message. That is, an administrator performs work in the application service 40 to enable a value of an input item of an application to be set using the generative AI system 50. The administrator may be a developer, for example.

The user terminal 10 or the developer terminal 60 is, for example, a terminal apparatus such as a personal computer (PC), a smartphone, or a tablet terminal, which is operated by the user or the developer. The terminal apparatus is an example of an information processing apparatus. The web browser or the native application operates on the user terminal 10 or the developer terminal 60. The developer operates the developer terminal 60 to create setting information related to the application. The administrator or the user operates the developer terminal 60 or the user terminal 10 to use various services provided by the generative AI system 50 or the application service 40.

The user terminal 10 or the developer terminal 60 may be an information processing apparatus. Examples of the information processing apparatus include an output apparatus such as an electronic whiteboard or a digital signage, a head-up display (HUD), an industrial machine, an imaging apparatus such as a digital camera, a sound collecting apparatus, a medical device, a network home appliance, a mobile phone, a smartphone, a tablet terminal, a car navigation system, a game machine, a personal digital assistant (PDA), and a wearable PC.

### Example of Hardware Configuration

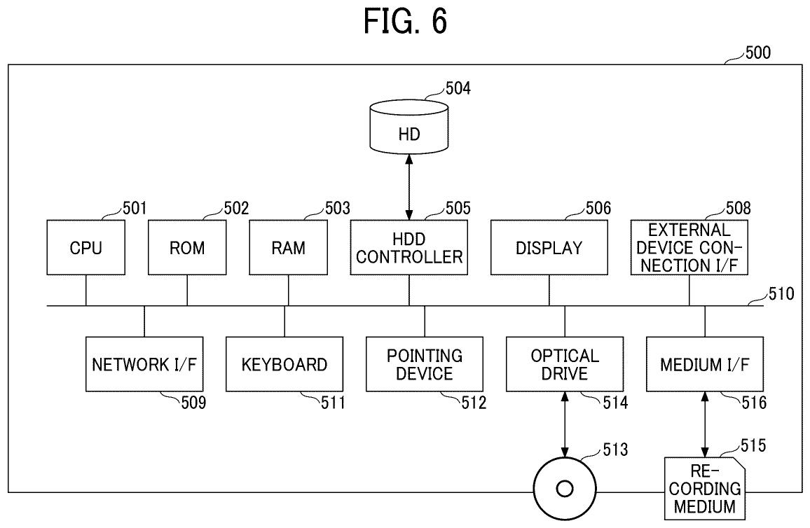

A hardware configuration of the application service 40, the user terminal 10, and the developer terminal 60 included in the information processing system 100 will be described with reference to FIG. 6. The generative AI system 50 has substantially the same hardware configuration as that illustrated in FIG. 6 or a hardware configuration of an information processing apparatus that supports cloud computing.

### Application Service, User Terminal, and Developer Terminal

FIG. 6 is a diagram illustrating an example of the hardware configuration of the application service 40, the user terminal 10, and the developer terminal 60. The application service 40, the user terminal 10, and the developer terminal 60 are each implemented by a computer 500. As illustrated in FIG. 6, the computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls the entire operation of the computer 500. The ROM 502 stores a program for driving the CPU 501, such as an initial program loader (IPL). The RAM 503 is used as a work area for the CPU 501. The HD 504 stores various kinds of data such as a program. The HDD controller 505 controls reading or writing of various kinds of data from or to the HD 504 under the control of the CPU 501. The display 506 displays various kinds of information such as a cursor, a menu, a window, text, or an image. The external device connection I/F 508 is an interface that connects various external devices to the computer 500. Examples of the external devices include a Universal Serial Bus (USB) memory and a printer. The network I/F 509 is an interface for performing data communication using the network N1 or N2. The bus line 510 is, for example, an address bus or a data bus for electrically connecting the components such as the CPU 501 illustrated in FIG. 6 to one another.

The keyboard 511 is an example of an input device that includes a plurality of keys for inputting characters, numerical values, or various instructions. The pointing device 512 is another example of the input device that allows the user to select or execute a specific instruction, select a target for processing, or move the cursor. The optical drive 514 controls reading or writing of various types of data from or to an optical recording medium 513. The optical recording medium 513 is an example of a removable recording medium. Examples of the optical recording medium 513 include a digital versatile disc (DVD) and a compact disc (CD). The medium I/F 516 controls reading or writing (storing) of data from or to a recording medium 515 such as a flash memory.

### Functions

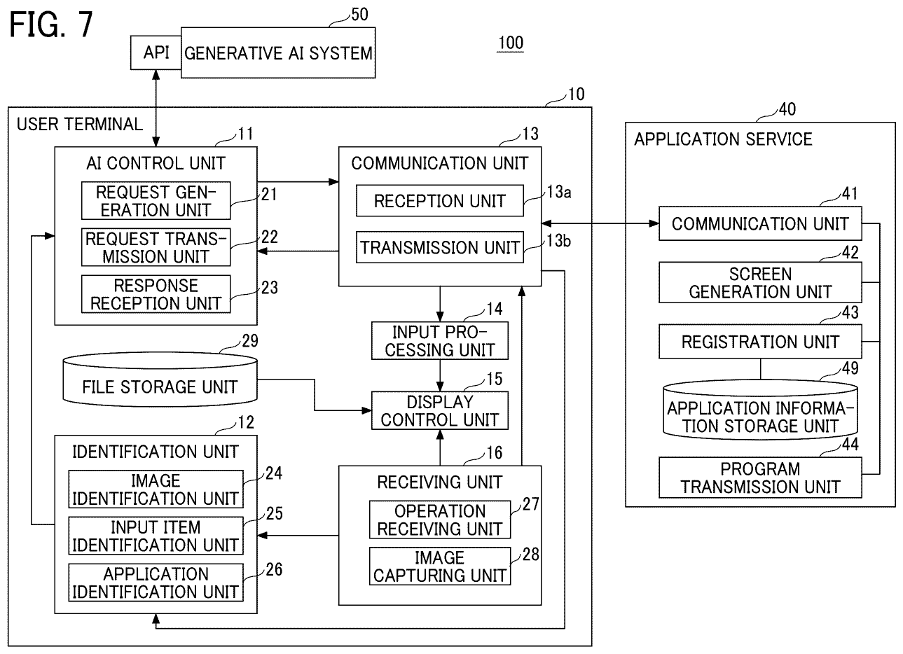

A functional configuration of the information processing system 100 will be described below with reference to FIG. 7. FIG. 7 is a diagram illustrating an example of the functional configuration of the application service 40 and the user terminal 10.

### User Terminal

The user terminal 10 includes an AI control unit 11, an identification unit 12, a communication unit 13, an input processing unit 14, a display control unit 15, and a receiving unit 16. These functional units are functions or units that are implemented by the CPU 501 illustrated in FIG. 6 executing instructions included in one or more programs installed on the user terminal 10. For example, the AI control unit 11, the input processing unit 14, the identification unit 12, the communication unit 13, the display control unit 15, and the receiving unit 16 may be implemented by a web browser and a web application. The web application is transmitted from the application service 40 to the user terminal 10. When the user terminal 10 executes a native application, the native application implements the AI control unit 11, the input processing unit 14, the identification unit 12, the communication unit 13, the display control unit 15, and the receiving unit 16.

The user terminal 10 includes a file storage unit 29. The file storage unit 29 stores image data files of business cards, for example.

The communication unit 13 transmits and receives various types of information to and from the application service 40 and the generative AI system 50. The communication unit 13 includes a reception unit 13a and a transmission unit 13b. In the present embodiment, the reception unit 13a receives the application-related information such as the application name and the list of input items from the application service 40. The transmission unit 13b requests the application service 40 to register values to the application in association with the respective input items.

The receiving unit 16 includes an operation receiving unit 27 and an image capturing unit 28. The operation receiving unit 27 receives various user operations on various screens displayed on the display 506. The operation receiving unit 27 receives selection of image data of a business card stored as a file in the file storage unit 29. The image capturing unit 28 controls a camera built in or externally attached to the user terminal 10 to capture an image of an object such as a business card and generate image data, for example. The object is not limited to a business card and may be any object including information to be managed by the application.

The identification unit 12 includes an image identification unit 24, an input item identification unit 25, and an application identification unit 26. The image identification unit 24 identifies image data uploaded by the user. The image data may be captured image data or image data of a selected file. That is, the image identification unit 24 identifies, as extraction-target image data, image data to be uploaded to the generative AI system 50. Based on the list of input items acquired from the application service 40, the input item identification unit 25 identifies an input item for which a value is to be generated. Based on the application name acquired from the application service 40, the application identification unit 26 identifies an application for which a value is to be generated.

The AI control unit 11 includes a request generation unit 21, a request transmission unit 22, and a response reception unit 23.

The request generation unit 21 generates a request message for calling an API made publicly available by the generative AI system 50. The request message requests the generative AI system 50 to generate information. APIs of the generative AI system 50 are made publicly available. The request transmission unit 22 calls an API to transmit a request message including a chat message to the generative AI system 50. As described above, the request message is information including a chat message. The chat message may be referred to as a request message, which is common in HTTP communication. The request message includes a text portion and image data. The text portion is called a prompt. The image data may be the image data itself or a URL associated with the image data. The request message may further include audio data. The request transmission unit 22 transmits, to the generative AI system 50, a request including an instruction to extract a value corresponding to an input item from the application-related information such as the image data, the application name, and the list of input items. This request is a request message generated by the request generation unit 21. The response reception unit 23 receives a response message from the generative AI system 50. The response message includes values associated with the respective input items.

The input processing unit 14 inputs the values corresponding to the respective input items transmitted from the generative AI system 50 to the respective input fields of the input items.

The display control unit 15 interprets screen information of various screens to display the screens on the display 506.

The display control unit 15 displays, for the input items, the respective values associated with the input items by the input processing unit 14.

### Application Service

The application service 40 includes a communication unit 41, a screen generation unit 42, a registration unit 43, a program transmission unit 45, and an application information storage unit 49. These functional units of the application service 40 are functions or units implemented as a result of the CPU 501 illustrated in FIG. 6 executing instructions included in one or more programs installed on the application service 40. The application information storage unit 49 is implemented by, for example, the HD 504 or the RAM 503 illustrated in FIG. 6. The application information storage unit 49 is not necessarily included in the application service 40. In some embodiments, the application information storage unit 49 is on a network accessible from the application service 40.

The communication unit 41 transmits and receives various types of information to and from the user terminal 10. In response to a request from the user terminal 10, the communication unit 41 transmits the application-related information such as the application name and the list of input items to the user terminal 10. The communication unit 41 transmits a web application to be executed by the user terminal 10 and screen information used by the web application for displaying screens to the user terminal 10.

The screen generation unit 42 generates the screen information of screens to be displayed by the user terminal 10. The screen information is a program written in Hypertext Markup Language (HTML), JSON, Extensible Markup Language (XML), a script language, a Cascading Style Sheet (CSS), and the like. The screen information may be referred to as a web page. The structure of the web page is specified by HTML, the operation of the web page is defined by the script language, and the style of the web page is specified by the CSS. The user terminal 10 may execute a native application. The native application is an application that becomes executable once the application is installed on the user terminal 10. In the case of the native application, the user terminal 10 holds the configuration of the screens, and information to be displayed is transmitted in the form of JSON, XML, or the like.

The registration unit 43 manages application information in the application information storage unit 49 on an application-by-application basis. The registration unit 43 registers a value corresponding to an input item transmitted from the user terminal 10 to the application information storage unit 49. The application information includes information set for the input items of the application and information related to the input items of the application.

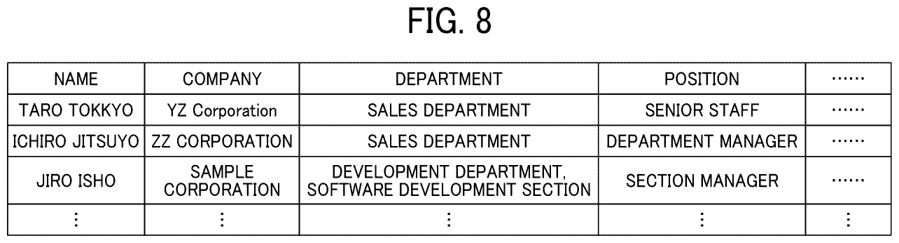

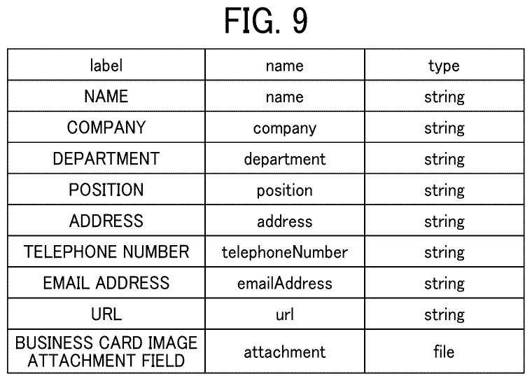

Thus, the application information storage unit 49 stores the information set for the input items of the application and the information related to the input items (see FIGS. 8 and 9).

In response to a request for a program transmitted from the user terminal 10, the program transmission unit 45 transmits the program to the user terminal 10. This program is a web application, and more specifically, JavaScript® included in the web application, for example.

FIG. 8 illustrates an example of information set for input items of an application. The information set for these input items includes information manually set by the user and information generated by the generative AI system 50. FIG. 8 illustrates the information set for the input items of the application by taking the business card management application as an example. The information set for the input items is managed on a record-by-record basis.

In the case of the business card management application, information of one record is referred to as business card information. In the case of the business card management application, input items include “name”, “company”, “department”, and “position”. Values are stored for the respective input items.

FIG. 9 illustrates an example of the information related to the input items of the application. The information related to the input items defines what kind of information is to be stored for each of the input items.

An item “label” indicates a name, that is, a so-called label, of each input item displayed on the input screen 210 of the business card management application.

An item “name” indicates identification information of each input item used by the application service 40 for management and identification of the input item.

An item “type” indicates the data format of the input item.

### Operations or Processes

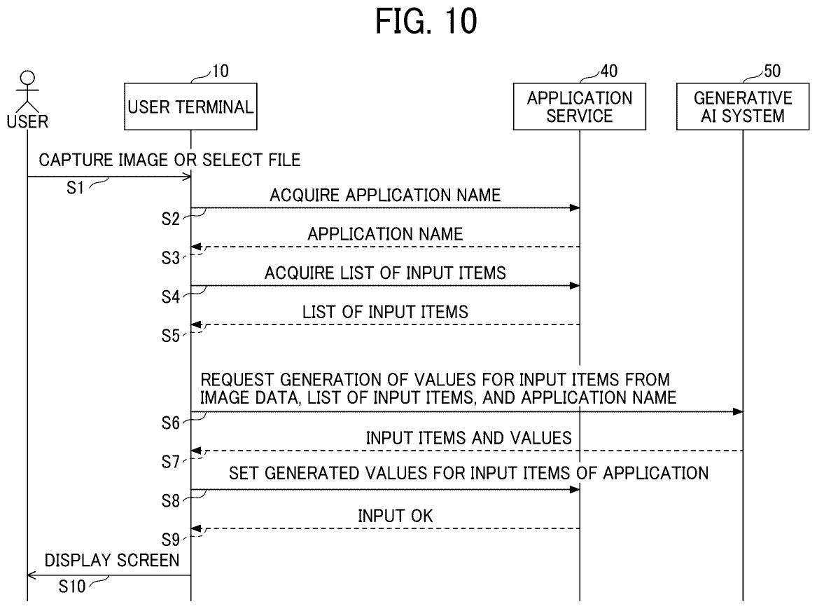

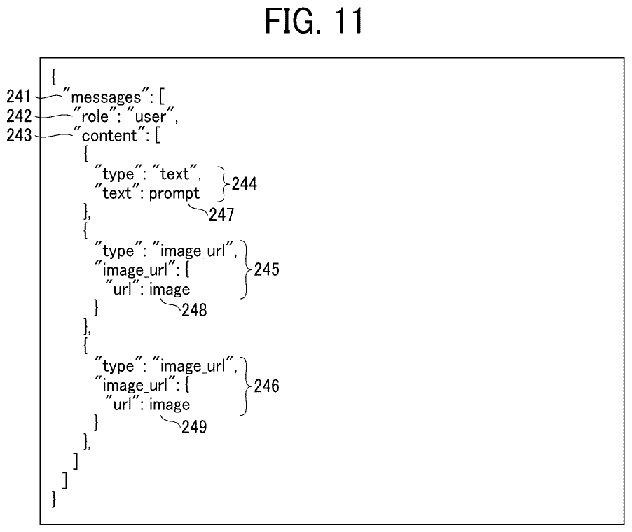

An overall procedure of a process performed by the information processing system 100 will be described below with reference to FIG. 10. FIG. 10 is a sequence diagram illustrating an example of the process performed by the information processing system 100. The business card management application is already registered to the application service 40.
S1: The user terminal 10 displays the input screen 210 of the business card management application. When the input screen 210 of the business card management application is implemented by the web application, the transmission unit 13b transmits a request for one or more programs to be executed by the user terminal 10 to the application service 40. The program transmission unit 45 of the application service 40 transmits the web application to the user terminal 10. The web application includes a program. The program causes a process to be executed. The process includes displaying a screen for receiving input of a value to an input field from a user. The screen is a screen on which an instruction to extract information to be input to the input field from image data is receivable. The process includes, when the instruction is received on the screen, transmitting a request to the generative AI system 50. The request includes the image data serving as an extraction target and an instruction to extract a value corresponding to an input item from the image data. The process includes receiving the value corresponding to the input item from the generative AI system 50. The process includes inputting the received value to the input field of the corresponding input item. The process includes transmitting the value input in the input field to the application service 40 to manage the value in the application service 40.

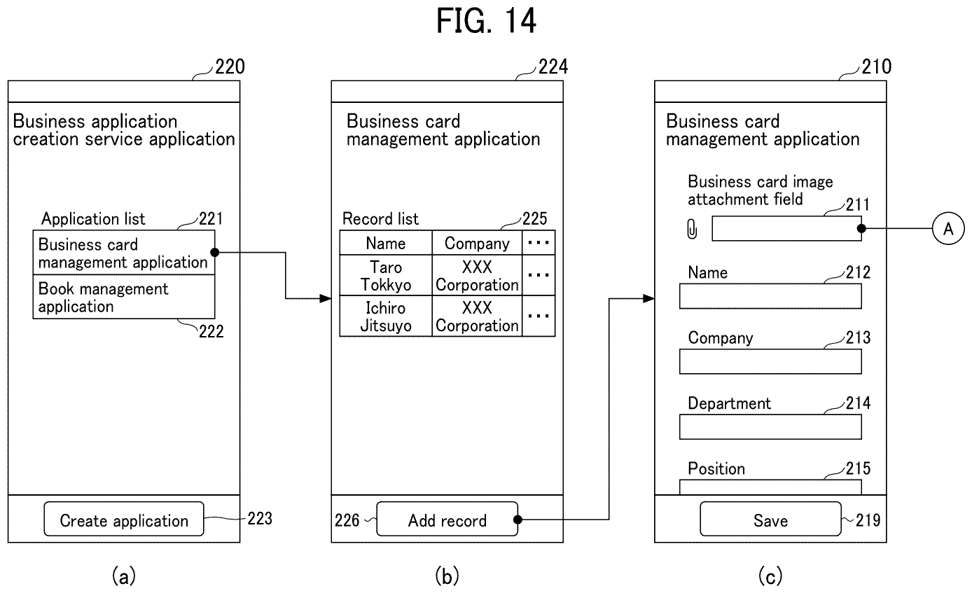

The user presses the business card image attachment field 211 illustrated in FIG. 14(c) described below. Since this allows selection of image capturing or file selection, the user inputs, to the user terminal 10, which method to use to prepare image data of a business card. The operation receiving unit 27 of the user terminal 10 receives the selection. When the user selects image capturing, the receiving unit 16 calls the image capturing unit 28 in accordance with an instruction received by the operation receiving unit 27 from the user. The image capturing unit 28 controls the camera to generate image data of a business card. The receiving unit 16 receives input of the image data captured by the image capturing unit 28. When the user selects file selection, the display control unit 15 displays a list of pieces of image data stored in the file storage unit 29. The operation receiving unit 27 receives selection of any image data from the list of pieces of image data. The receiving unit 16 receives input of image data for which the operation receiving unit 27 has received the selection from among the pieces of image data stored in the file storage unit 29. The business card image attachment field 211 displays the file name of the image data. A thumbnail of the image data may further be displayed.

In the present embodiment, this setting of the image data in the business card image attachment field 211 triggers AI-powered image analysis/input. The AI-powered image analysis/input refers to a processing sequence of analyzing image data to generate a value for an input item and setting the value to the application service 40.
S2: After the AI-powered image analysis/input is started, the communication unit 13 of the user terminal 10 designates identification information of the application and requests the application service 40 to provide the application name. At this time point, the application displayed by the user terminal 10 is identified. Thus, the identification information of the application is known. When a value is set to an application that is not displayed by the user terminal 10, the user selects the application, for example. The application name is requested because the analysis of the application name by the generative AI system 50 increases the accuracy of generating the appropriate value for the input item. Therefore, the application name may be omitted. The user terminal 10 may request the explanation note of the application instead of the application name. The explanation note of the application is “This application is an application for managing business cards”, for example.
S3: The communication unit 41 of the application service 40 receives the request. The registration unit 43 acquires the application name from application information identified by the identification information of the application. The communication unit 41 of the application service 40 transmits the application name to the user terminal 10. The reception unit 13a of the user terminal 10 receives the application name.
S4: The communication unit 13 of the user terminal 10 then designates the identification information of the application and requests the application service 40 to provide the list of input items. More specifically, since the label items are appropriate for the input items used by the generative AI system 50, the reception unit 13a receives a list of label items.
S5: The communication unit 41 of the application service 40 receives the request, and the registration unit 43 acquires the list of input items from the information related to the input items identified by the identification information of the application. The communication unit 41 of the application service 40 transmits the list of input items to the user terminal 10. The reception unit 13a of the user terminal 10 receives the list of input items.
S6: The request generation unit 21 of the user terminal 10 generates a request message using the application-related information. The request message includes the image data of the business card, the application name, and the list of input items. This request message includes an instruction to extract information corresponding to the input items from the image data. The request transmission unit 22 transmits a request to generate values for the input items to the generative AI system 50 together with this request message. FIG. 11 illustrates a description example of this request message.
S7: The generative AI system 50 analyzes the image data of the business card to generate the values for the input items, and determines correspondences between the values and the input items. The generative AI system 50 transmits a response message to the user terminal 10. The response message includes the input items and the generated values. The response reception unit 23 of the user terminal 10 receives the input items and the generated values.
S8: The communication unit 13 of the user terminal 10 generates a request message that requests the setting of the input items and the generated values to the application. The transmission unit 13b transmits this request message to the application service 40.
S9: The communication unit 41 of the application service 40 receives the request message. The registration unit 43 saves the values in the application information storage unit 49 in association with the respective input items of the application. The communication unit 41 of the application service 40 transmits “input OK”, which means that the registration of the value is completed, to the user terminal 10. The reception unit 13a of the user terminal 10 receives the “input OK”.
S10: The transmission unit 13b of the user terminal 10 transmits a screen update request to the application service 40, and the reception unit 13a of the user terminal 10 receives the latest application information. Thus, the input processing unit 14 inputs the values corresponding to the input items to the respective input fields of the input items. The display control unit 15 displays the input screen 210 of the business card management application in which the values are set for the input items.
   Example of Request Message from User Terminal 10 to Generative AI System 50

FIG. 11 illustrates parameters included in the request message transmitted by the user terminal 10 to the generative AI system 50 in step S6 in FIG. 10.

“messages” 241 is an API of the generative AI system 50 and indicates that the following is a chat message.

“role” 242 is an API of the generative AI system 50 and indicates a category of the source of the request message. The categories include “user” indicating the user, “assistant” indicating AI of the generative AI system 50, and “system” indicating a setting instruction from the AI assistant.

“content” 243 is an API of the generative AI system 50, and a dialog is set in the “content” 243. Since the “content” has an array structure, a prompt and a plurality of pieces of image data may be set. In FIG. 11, three parameters 244 to 246 are written in the JSON format. Two of the three parameters 244 to 246 are image data.

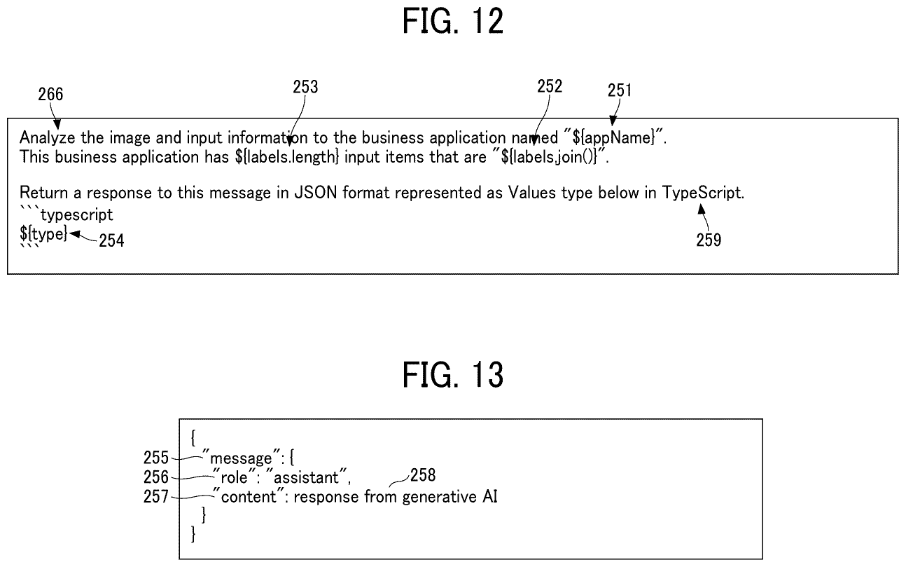

The parameters 244 to 246 are in the format of information transmitted to the generative AI system 50. “type” defines the data type. When the “type” is “text”, the value of the “text” is “prompt” 247. In the “prompt” 247, a prompt is set. FIG. 12 illustrates an example of the prompt set in the “prompt” 247.

When the “type” is “image_url”, the value of the “image_url” is “image” 248 or 249. In the “image” 248 or 249, a URL where image data is saved or an image encoded by Base64 is input. When the application has one input item for image data, the parameters 245 and 246 may be reduced to one.

The request message including the prompt and the images as illustrated in FIG. 11 is transmitted to the generative AI system 50.

FIG. 12 is a diagram illustrating the prompt set in the “prompt” 247 in FIG. 11. A character string illustrated in FIG. 12 is a template used by the request generation unit 21 to create a prompt. The character string includes four ${ . . . } expressions. When the request message is transmitted, the application-related information is set in ${appName} 251, $ {labels.join()} 252, ${labels.length} 253, and ${type} 254. That is, the four ${ . . . } expressions are replaced with the application-related information. The rest of the character string is fixed and is held by the request generation unit 21 in advance. “Analyze the image” 266 at the beginning of the prompt requests analysis of the image data designated by the parameter 245 included in the request message.

The application name is set in the ${appName} 251. In some embodiments, the application name may be omitted. In some embodiments, the explanation note of the application, which describes the application, may be set.

The list of input items is set in the ${labels.join()} 252.

The number of input items is set in the ${labels.length} 253.

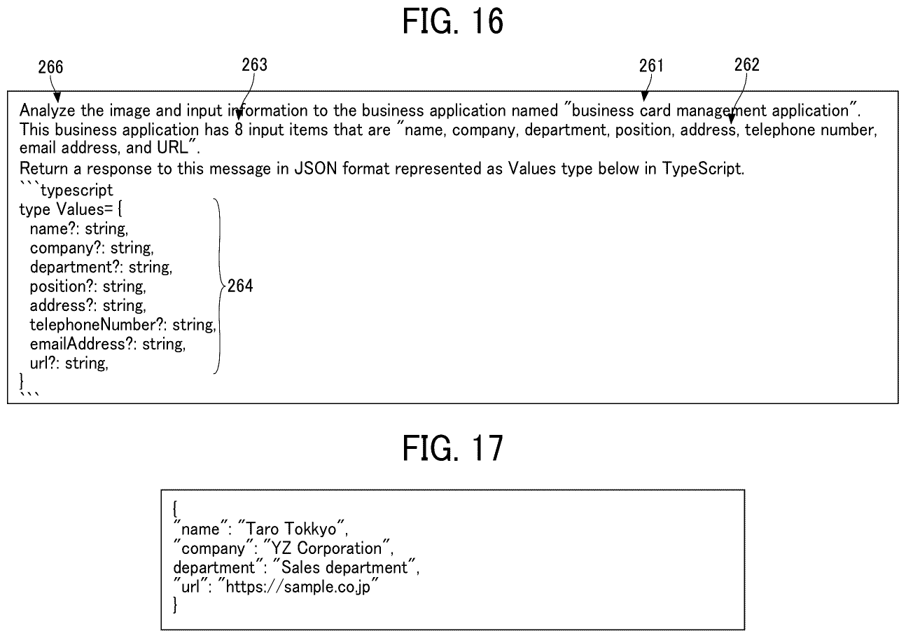

The data format of the input items to be returned in the response message is set in the ${type} 254. “TypeScript” 259 is a statically typed programming language that allows declaration of variable data types within code. In FIG. 12, the JSON format is designated for the ${type} 254. That is, the prompt illustrated in FIG. 12 instructs the generative AI system 50 to return input items and respective values in the JSON format. A specific setting example will be described with reference to FIG. 16.

Example of Response Message from Generative AI System 50 to User Terminal 10

FIG. 13 illustrates a format of a response message transmitted by the generative AI system 50 to the user terminal 10 in step S7 in FIG. 10. That is, FIG. 13 presents the format rather than the response message itself.

“messages” 255 indicates that the following is a response message.

“role” 256 indicates a category of a sender that transmits the response message. In this example, the sender is “assistant”, which means AI of the generative AI system 50.

“content” 257 presents the content of the response message. In this example, the “content” 257 presents a response 258 from the generative AI system 50. The response 258 includes input items and respective values. The details of the response 258 from the generative AI system 50 will be described with reference to FIG. 17.

### Example of Setting Values for Input Items Using Image Data

An example of setting values for input items using image data will be described below using the business card management application as an example.

### Example of Setting Information Using Image Data of Business Card

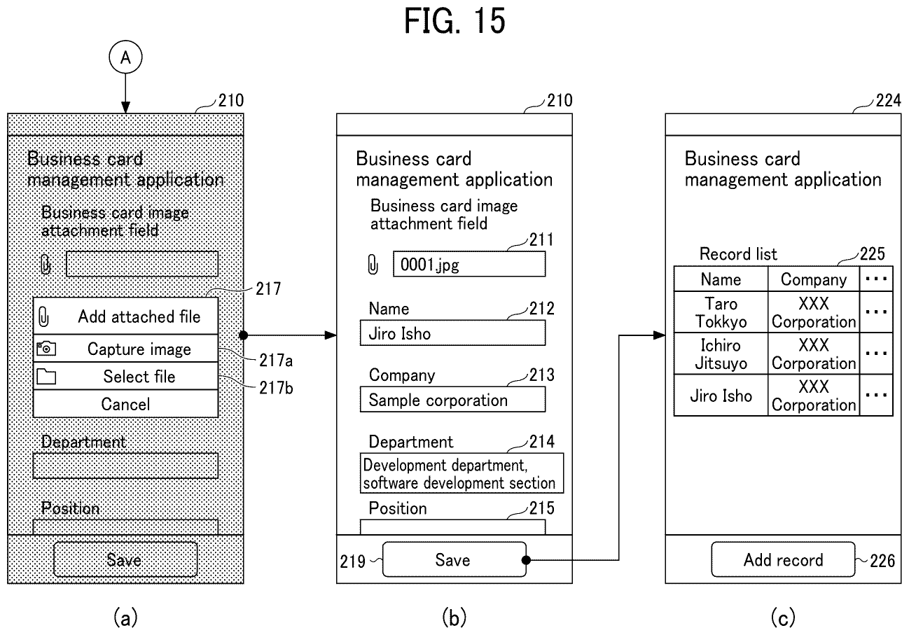

With reference to FIG. 14 and other drawings, an example of setting values for input items of the business card management application will be described. FIGS. 14 and 15 illustrate the transition of the input screen 210 of the business card management application displayed by the user terminal 10. Differences from FIG. 3 may be described in the description of FIGS. 14 and 15. FIG. 14(a) to 14(c) may be identical or similar to FIG. 3(a) to 3(c).

In the input screen 210 of the business card management application in FIG. 14(c), the user presses the business card image attachment field 211. Consequently, a selection menu 217 illustrated in FIG. 15(a) is displayed as a pop-up window. Displaying the selection menu 217 as the pop-up window is an example, and the selection menu 217 may be displayed as a pull-down menu from the business card image attachment field 211, for example. The selection menu 217 includes a capture image button 217a and a select file button 217b. The user selects one of the methods to use to prepare the image data of the business card.

When the user selects the capture image button 217a, a camera activates and captures an image. The resultant image data file can be set in the business card image attachment field 211. When the user selects the select file button 217b, the user terminal 10 displays a list of files saved in the user terminal 10 to allow the user to select a file from the list. The selected file is set in the business card image attachment field 211. With the select file button 217b, a document file such as a Portable Document Format (PDF) or Word file as well as an image file such as a Joint Photographic Experts Group (JPEG) or Portable Network Graphics (PNG) file is selectable. For example, when an invoice recording application has been created in the business application creation service, values can be input to the invoice recording application from invoices such as PDF, Word, and Excel® files by using the generative AI system 50.

After a file, for example, “0001.jpeg” is set in the business card image attachment field 211 as in FIG. 15(b), AI-powered image analysis/input starts. At this time point, fields such as the name field 212, the company field 213, the department field 214, and the position field 215 are empty. The user terminal 10 uses the generative AI system 50 to generate values and input the values for the input items. Thus, the values are set in the name field 212, the company field 213, the department field 214, and the position field 215.

The fields such as the name field 212, the company field 213, the department field 214, and the position field 215 are editable. The user checks these generated values, edits the values as desired, and presses the save button 219. The values generated by the generative AI system 50 may be saved without pressing the save button 219 by the user. In this case, the user can check and edit the values later. When the save button 219 is pressed, the processing in step S8 in FIG. 10 is executed. Thus, the record list 224 in FIG. 15(c) is displayed. As described above, the values can be input from image data instead of the user inputting the values for the input items.

The image data file set in the business card image attachment field 211 may be saved in the business application creation service, or may be used as input to the generative AI system 50 and not saved in the business application creation service.

In FIG. 14, a new record is analyzed and the resultant information is set for the items. When the user selects an existing record in FIG. 14(b), information can also be set for the items. In this case, the information of the items may be overwritten, or the information set before the update may be saved.

The application-related information of the business card management application will be described. The application name of the business card management application is “business card management application”. According to the information related to the input items in FIG. 9, the list of input items, specifically, the list of label items, includes the name, the company, the department, the position, the address, the telephone number, the email address, the URL, and the business card image attachment field. Among these input items, the AI-powered image analysis/input is not performed for the business card image attachment field. Thus, the request generation unit 21 does not include the business card image attachment field in the prompt. The request generation unit 21 uses the input items whose type item is string type in the information related to the input items as the prompt. Thus, the request generation unit 21 can exclude, from the prompt, the input item for which the value is not to be input. Thus, the list of input items is the name, the company, the department, the position, the address, the telephone number, the email address, and the URL. The number of input items is 8.

The input screen 210 of the business card management application is a screen on which the image data is uploaded. The image identification unit 24 identifies the uploaded image data as an image from which the values are to be extracted. The reception unit 13a receives information for identifying the application selected by the user. Based on the information for identifying the application, the input item identification unit 25 identifies the input items using the information related to the input items illustrated in FIG. 9. The image identification unit 24 identifies the image data uploaded by the user. The application identification unit 26 identifies the application name of the application.

FIG. 16 illustrates the prompt generated by the request generation unit 21. The following information is set in the ${appName} 251, the ${labels.join()} 252, and the $ {labels.length} 253 illustrated in FIG. 12.

In the ${appName} 251, “business card management application” 261 is set.

In the ${labels.join()} 252, “name, company, department, position, address, telephone number, email address, and URL” 262 is set. That is, the label items in the information related to the input items are set. The name items are not set because the name items serve as the identification information, and information irrelevant to the labels, for example, information with which the generative AI system 50 has difficulty determining the input items, is often set for the name items.

In the ${labels.length} 253, “8” 263 is set.

In the ${type} 254 illustrated in FIG. 12, a data format 264 of each input item is set. The data format 264 is an instruction to extract information written in the data format as follows:
“name?: string,
company?: string,
department?: string,
position?: string,
address?: string,
telephoneNumber?: string,
emailAddress?: string,
url?: string”.

These are values of the name items and the type items in the information related to the input items illustrated in FIG. 9. The name items of the data format 264 are arranged in the same order as the “name, company, department, position, address, telephone number, email address, and URL” 262.

The label items are not used instead of the name items in the data format 264 because the values for the input items returned by the generative AI system 50 are transmitted to the application service 40 by the user terminal 10. The application service 40 identifies the input items not by the values of the label items but by the values of the name items. In some embodiments, however, the values of the label items may be used. In this case, when the values are set to the application service 40, the request generation unit 21 converts the label items into the name items.

“?” at the end of each name item indicates that if there is an input item whose value is not found in the image data, the generative AI system 50 may omit the input item. “string” is the value, namely, the data type, of the type item.

Based on “Analyze the image” 266 at the beginning of the prompt, the generative AI system 50 grasps the instruction to analyze the image data designated by the parameter 245 included in the request message. The generative AI system 50 then attempts to generate values of the “name, company, department, position, address, telephone number, email address, and URL” 262 from the image data. The generative AI system 50 then determines input items for which values are successfully generated based on the arrangement order in the data format 264, and associates each input item with the corresponding generated value.

FIG. 17 illustrates the response message from the generative AI system 50 in response to the request message including the prompt illustrated in FIG. 16. The generative AI system 50 analyzes the image data of the business card to acquire values corresponding to the “name, company, department, position, address, telephone number, email address, and URL” 262. The generative AI system 50 then associates the values with the respective name items included in the data format 264 of the prompt, and returns the values and the respective name items. The name items may be referred to as input items below.
Input item: Value
name: Taro Tokkyo
company: Sample1 corporation
department: sales department
url: https://sample.co.jp

The response message does not include “position”, “address”, “telephoneNumber”, and “emailAddress” among the input items included in the data format 264 of the prompt because the “position”, “address”, “telephoneNumber”, and “emailAddress” are not included in the image data of the business card or are not found by the generative AI system 50.

The user terminal 10 uses the response message illustrated in FIG. 17 to request the application service 40 to set the values to the business card management application in step S8 in FIG. 10.

As illustrated in FIG. 15(b), the input processing unit 14 inputs the values corresponding to the respective input items to the respective input fields of the input items. That is, the values included in the response message are set for the respective input items. The values generated by the generative AI system 50 are set in the name field 212, the company field 213, the department field 214, and the position field 215.

As described above, the user designates image data of a business card, so that values obtained through analysis of the image data of the business card can be automatically set for the respective input items. The user terminal 10 acquires the application-related information from the application service 40, and thus can set an appropriate value extracted from the image data for an input item of a given application in addition to the business card management application.

### Modifications of Screen Transition

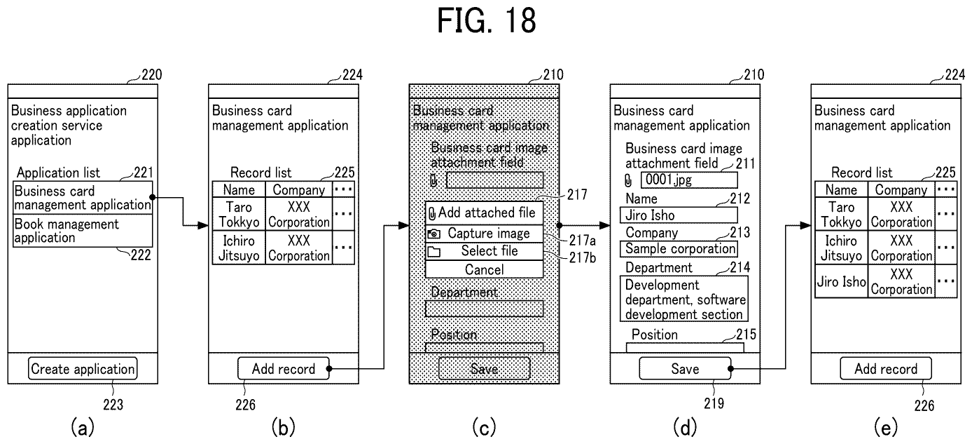

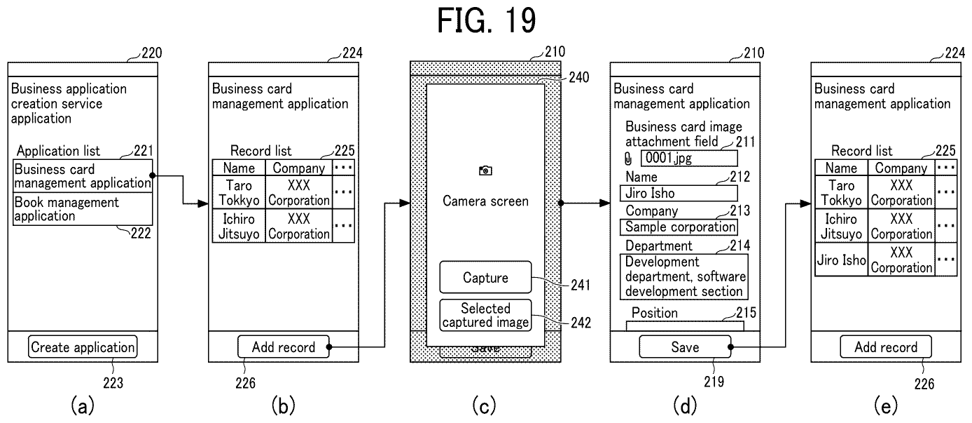

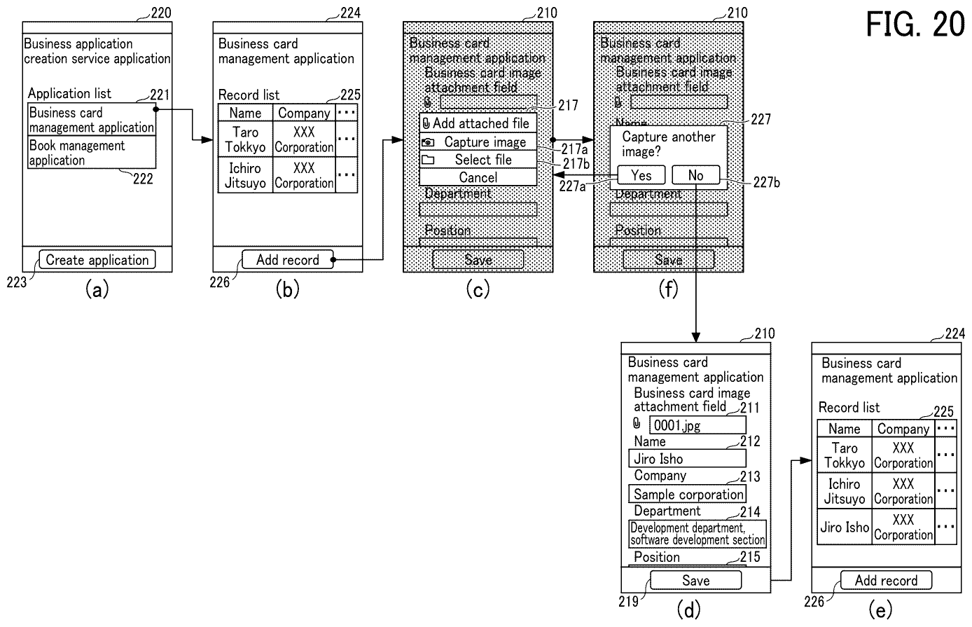

Screen transition according to a modification will be described with reference to FIGS. 18 and 20. FIGS. 18 and 20 illustrate the screen transition of the business card management application displayed by the user terminal 10. In the description of FIGS. 18 and 19, differences from FIGS. 14 and 15 will be described. In FIG. 18, when the user presses the add record button in FIG. 18(b), the selection menu 217 is immediately displayed as illustrated in FIG. 18(c). That is, the input screen 210 of the business card management application illustrated in FIG. 14(c) is skipped.

The input screen 210 of the business card management application illustrated in FIG. 18(d) may also be skipped, AI-powered image analysis/input may be performed in response to the setting of the image data, and the record list 224 illustrated in FIG. 18(e) may be displayed. That is, the screen transitions in order of FIG. 18(a), FIG. 18(b), FIG. 18(c), and FIG. 18(e). This can reduce the number of user operations.

In FIG. 19, when the user presses the add record button in FIG. 19(b), a camera screen 240 is displayed as illustrated in FIG. 19(c). The camera screen 240 displays a real-time video. The camera screen 240 includes a capture button 241 and a select file button 242. When the user presses the capture button 241, a file of image data is set in the business card image attachment field 211. When the user presses the select file button 242, the list of files is displayed and a file selected from the list is set in the business card image attachment field 211. This can reduce the number of user operations as compared with when the selection menu 217 is displayed.

In FIG. 19(c), a file list screen may be displayed instead of the camera screen 240. The user may set in advance which of the camera screen 240 and the file list screen is to be displayed.

In FIG. 19, the input screen 210 of the business card management application illustrated in FIG. 19(d) may be skipped, AI-powered image analysis/input may be performed in response to the designation of the image data, and the record list 224 illustrated in FIG. 19(e) may be displayed. That is, the screen transitions in order of FIG. 19(a), FIG. 19(b), FIG. 19(c), and FIG. 19(e). This can reduce the number of user operations.

As illustrated in FIG. 20, the user may capture a plurality of images. In FIG. 20, a dialog 227 illustrated in FIG. 20(f) is added to the screen transition illustrated in FIG. 18. When the user captures a photograph, the dialog 227 is displayed to allow the user to select a yes button 227a or a no button 227b. When the yes button 227a is pressed, the selection menu 217 illustrated in FIG. 20(c) is displayed. The user selects image capturing or file selection to collectively designate a plurality of pieces of image data. When the no button 227b is pressed, the screen transitions to the screen illustrated in FIG. 20(d).

The variations of the screens illustrated in FIG. 18 to 20 are also applicable to a second embodiment.

Generation of Values using Function Call Capability

The information processing system 100 that sets values for respective input items using a function call capability provided by the generative AI system 50 will be described below. The description will be given assuming that the hardware configuration diagram in FIG. 6 and the functional block diagram in FIG. 7 can also be used.

### Request Message When Function Call Capability is Available

The generative AI system 50 may have the function call capability. The user terminal 10 specifies a function and types of arguments of the function for the generative AI system 50. The generative AI system 50 generates the arguments of the function in the specified format. This capability is called “function call capability”. The user terminal 10 or the application service 40 does not have a function to be called. The existence of such a function causes no issues. In the present embodiment, however, since no such function exists, the term “dummy function” is used. Although the term “function call capability” is used, the generative AI system 50 does not call a function of the user terminal 10 or the application service 40. In the present embodiment, the user terminal 10 specifies a function and types of arguments of the function for the generative AI system 50 using the function call capability in order to acquire the values for the input items in the formats specified by the user terminal 10 from the generative AI system 50 with increased certainty.

The use of the function call capability can increase the accuracy of the generative AI system 50 returning values in the JSON format as compared to the case where the user terminal 10 requests the generative AI system 50 to generate the values for the respective input items in the JSON format and the generative AI system 50 generates the values.

### Procedure of Process Using Function Call Capability

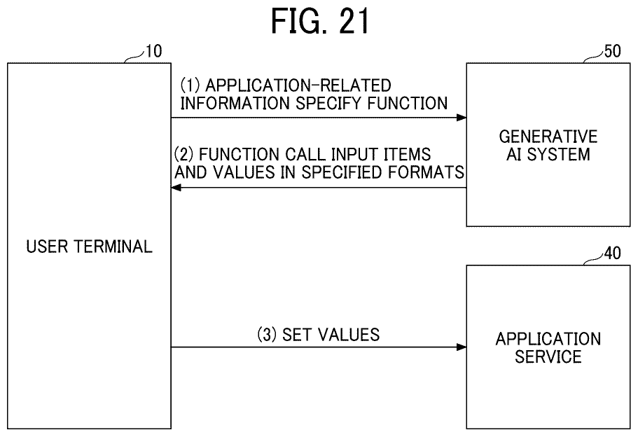

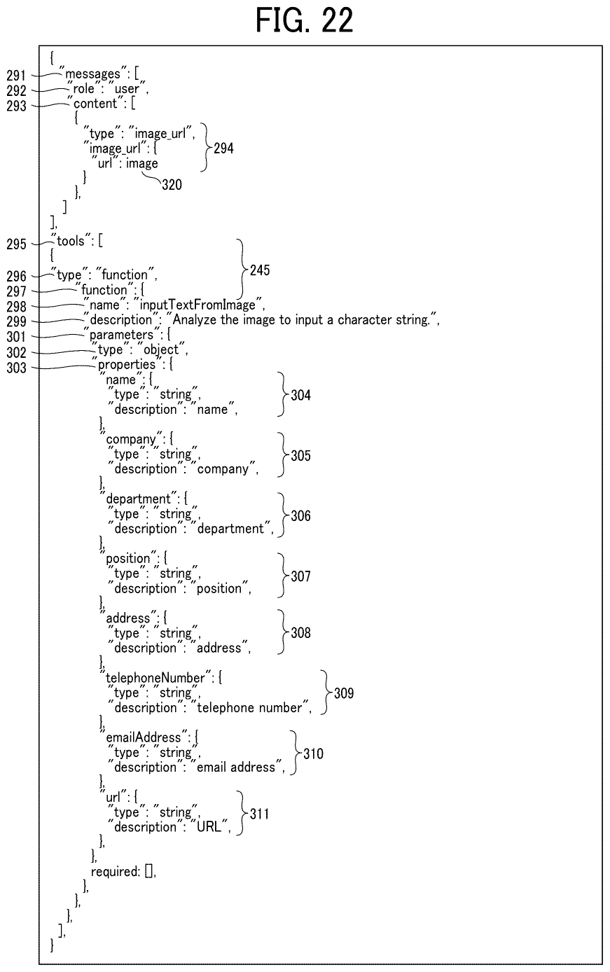

FIG. 21 is a diagram illustrating a method of setting values for input items using the function call capability. In FIG. 21, the user has already set an image data file to the business card image attachment field 211.
(1) The user terminal 10 includes types of arguments of a function in a request message and transmits the request message to the generative AI system 50. The function is a program interface that performs a preset process with a specified argument and returns a return value as a result. In the present embodiment, however, the user terminal 10 and the application service 40 do not have a function. The user terminal 10 includes formats of arguments of a function, namely, a dummy function, in a request message, and transmits the request message to the generative AI system 50. Consequently, it is expected that the function call from the generative AI system 50 includes the values for the respective input items in the format specified by the user terminal 10.

The generative AI system 50 requesting the user terminal 10 to call the dummy function that does not actually exist is called “function call”, namely, tool_call in the present embodiment.

If the user terminal 10 or the application service 40 actually has a function, this does not cause any issues. The user terminal 10 may execute the function to set the values to the application service 40.

In some embodiments, the user terminal 10 does not include the formats of the arguments of the function in the same request message as the request message including the application-related information. For example, the user terminal 10 may include the formats of the arguments of the function in another request message different from the request message including the application-related information and transmit the request messages to the generative AI system 50.
(2) Based on the application-related information and the formats of the arguments of the function included in the transmitted request message(s), the generative AI system 50 transmits a response message including the function call, namely, the tool_call, to the user terminal 10. The expression “the generative AI system 50 requests the user terminal 10 to call a function” does not indicate that the generative AI system 50 requests execution of the function but just proposes values for the input items in the specified format.

That is, the generative AI system 50 includes the input items and the respective values of the application transmitted from the user terminal 10 in a response message as arguments of the function. These values are generated through analysis of the application-related information.
(3) The user terminal 10 acquires the input items and the respective values included in the function call, namely, tool_call, included in the response message transmitted from the generative AI system 50, and requests the application service 40 to set the values for the respective input items. More specifically, the user terminal 10 generates a request message for calling an API of the application service 40, and transmits the generated request message to the application service 40. In the present embodiment, in response to the function call, the user terminal 10 sets the values for the input items in the application service 40 and does not execute the called function.

### Example of Request Message to Generative AI System 50 When Generative AI System 50 has Function Call Capability

FIG. 22 illustrates an example of a request message including the arguments of the function. The request message illustrated in FIG. 22 assumes the business card management application. “messages” 291, “role” 292, and “content” 293 are substantially the same as the “messages” 241, the “role” 242, and the “content” 243 in FIG. 11, respectively. A parameter 294 describes “type” of the input item being “image_url”. The value of the “image_url” is “image” 320. In the “image” 320, a URL where image data of a business card is saved or an image encoded by Base64 is input, for example.

The parameter 244, namely, the prompt, in FIG. 11 is replaced with “tools” 295.

The “tools” 295 is an API of the generative AI system 50 and indicates that the following specifies the formats of the arguments of the function.

“type”: “function” 296 indicates that the type of the object is a function.

“function” 297 indicates the description of the function. “name” 298 indicates the name of the function. “description” 299 indicates the capability of the function. The request generation unit 21 holds the “function” 297, the “name” 298, and the “description” 299 in advance. “parameters” 301 provides the description of the arguments of the function. “type”: “object” 302 indicates that the arguments are described in the object format. The “function” 297, the “name” 298, the “description” 299, and the “parameters” 301 are all APIs of the generative AI system 50.

“properties” 303 describes the list of pieces of information related to the input items of the business card management application in a nested structure of the JSON format. That is, the “properties” 303 requests the generative AI system 50 to return the arguments of the function in the JSON format.

“name” 304 specifies how the value for the input item “name” is to be returned. The input item “name” is acquired from the name item of the information related to the input items. Thus, the “name” 304 specifies the “type” of the input item “name” as “string”. “description” specifies returning “name” for the input item “name”. This “name” indicates a request to return the name determined by the generative AI system 50 through analysis of the image data.

The same applies to the following input items “company” 305, “department” 306, “position” 307, “address” 308, “telephoneNumber” 309, “emailAddress” 310, and “url” 311.

As described above, the “tools” 295 includes the list of input items of the application-related information. As in the first embodiment, the image data is included in the parameter 245 illustrated in FIG. 11. The request message illustrated in FIG. 22 does not include the application name. However, in some embodiments, the request message may include the application name. The “name” 298 or the “description” 299 serves as the application name, and may be regarded as the application name.

Based on the “name” 298 or the “description” 299, the generative AI system 50 grasps the instruction to analyze the image data designated by the parameter 245 included in the request message. The generative AI system 50 then attempts to generate values, specifically, the name, the company, the department, the position, the address, the telephone number, the email address, and the URL, of the “name” 304, the “company” 305, the “department” 306, the “position” 307, the “address” 308, the “telephoneNumber” 309, the “emailAddress” 310, and the “url” 311 from the image data. The generative AI system 50 returns the successfully generated values in the JSON format.

Example of Response Message from Generative AI System 50 to User Terminal 10

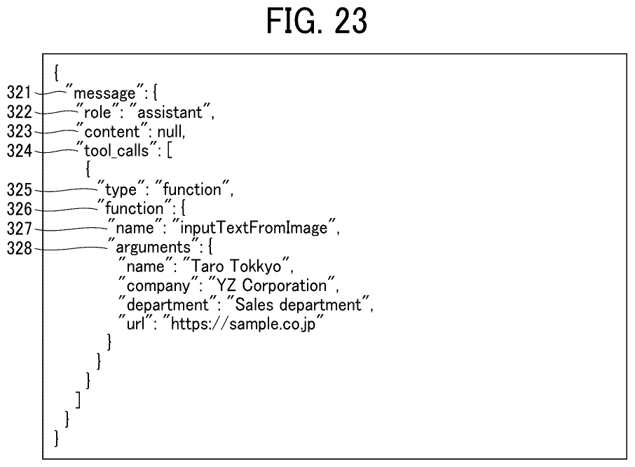

FIG. 23 illustrates an example of a response message from the generative AI system 50 when the generative AI system 50 has the function call capability. “messages” 321, “role” 322, and “content” 323 are substantially the same as the “messages” 255, the “role” 256, and the “content” 257 in FIG. 13, respectively. With the response message illustrated in FIG. 23, the generative AI system 50 requests the user terminal 10 to call a function.

“tool_calls” 324 indicates that the following description is a function call. That is, the generative AI system 50 requests the user terminal 10 to call the dummy function that does not actually exist. In some embodiments, the function may actually exist.

“type”: “function” 325 indicates that the type of the object is a function.

“function” 326 indicates the description of the function.

“name” 327 indicates the name of the function.

“arguments” 328 indicates the arguments of the function. The arguments include the input items and the respective values below. That is, the generative AI system 50 analyzes image data of a business card, and generates values in association with the respective name items, namely, input items, in the JSON format specified by the “properties” 303 in FIG. 22.
Input item: Value
name: Taro Tokkyo
company: sample1 corporation
department: sales department
url: https://sample1.co.jp

These input items and values match the information included in the response message illustrated in FIG. 17 according to the first embodiment. The user terminal 10 uses the response message illustrated in FIG. 23 to request the application service 40 to set the values to the business card management application.

Consequently, the values for the respective input items are set in the input screen 210 of the business card management application as illustrated in FIG. 17.

According to the present embodiment, the accuracy of the generative AI system 50 returning the values in the JSON format increases. Since the user terminal 10 can acquire the values for the respective input items in the JSON format, the user terminal 10 can set the values for the respective input items in the application service 40 with increased reliability.

### Second Embodiment

In the present embodiment, an information processing system 100 will be described in which an application service 40 transmits application-related information to a generative AI system 50. In the present embodiment, the description will be given assuming that the hardware configuration diagram in FIG. 6 and the functional block diagram in FIG. 7 described in the first embodiment can also be used.

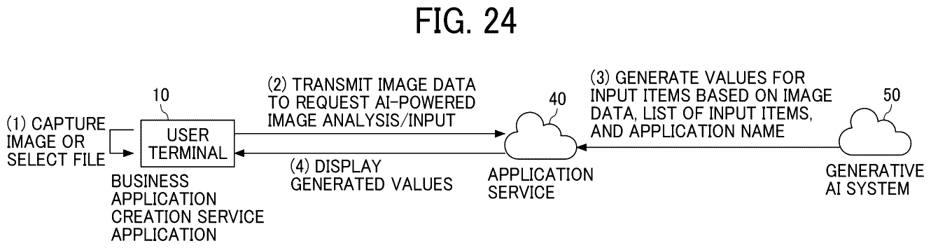

FIG. 24 is a diagram illustrating a process in which the information processing system 100 sets a value in the application service 40. In the description of FIG. 24, differences from FIG. 4 may be described.
(1) Processing may be substantially the same as that in FIG. 4.
(2) Triggered by an image-capturing operation or selection of a file, the user terminal 10 requests the application service 40 to perform AI-powered image analysis/input together with image data.
(3) The application service 40 identifies a list of input items and an application name of the application executed by the user terminal 10. In some embodiments, the application name may be omitted. In some embodiments, the application service 40 may acquire an explanation note of the application instead of the application name. The explanation note is an explanatory text of the application and is set in advance by the user. The application service 40 transmits application-related information such as the list of input items, the image data, and the application name to the generative AI system 50, and acquires values to be set for the input items. Specifically, the generative AI system 50 analyzes the image data, the list of input items, and the application name. The generative AI system 50 performs character recognition on the image data and generates a feature quantity indicating, for example, features of the image data to generate the values corresponding to the input items.
(4) The application service 40 transmits the values acquired from the generative AI system 50 to the user terminal 10 in association with the input items. Thus, the user terminal 10 displays the input screen in which the values are set for the respective input items to allow the user to check the generated values. In response to the user pressing a button such as a register button, the user terminal 10 transmits the values associated with the input items to the application service 40. The application service 40 sets the values in the record of the application.

As described above, the information processing system 100 according to the present embodiment sets a value for an input item of any application.

### Functions

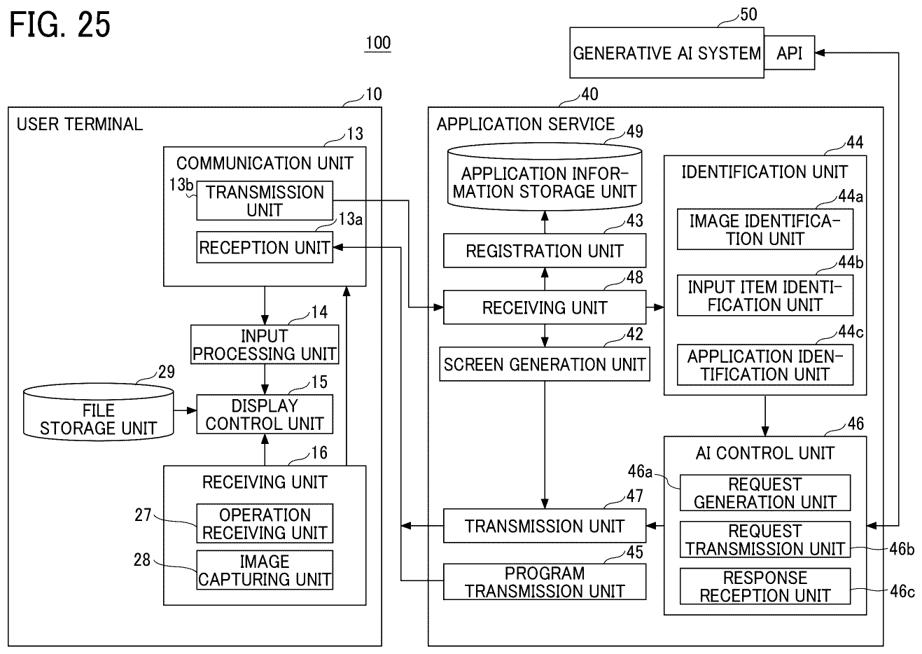

A functional configuration of the information processing system 100 will be described below with reference to FIG. 25. FIG. 25 is a diagram illustrating an example of the functional configuration of the application service 40 and the user terminal 10.

### User Terminal

The user terminal 10 includes a communication unit 13, an input processing unit 14, a display control unit 15, and a receiving unit 16. These functional units are functions or units that are implemented by the CPU 501 illustrated in FIG. 6 executing instructions included in one or more programs installed on the user terminal 10. For example, the communication unit 13, the input processing unit 14, the display control unit 15, and the receiving unit 16 may be implemented by a web browser and a web application. The web application is transmitted from the application service 40 to the user terminal 10. When the user terminal 10 executes a native application, the native application implements the communication unit 13, the input processing unit 14, the display control unit 15, and the receiving unit 16.

The communication unit 13 transmits and receives various types of information to and from the application service 40. The communication unit 13 includes a reception unit 13a and a transmission unit 13b. In the present embodiment, the reception unit 13a receives screen information of an input screen of an application from the application service 40. The transmission unit 13b transmits image data of a business card or the like to the application service 40, for example. The reception unit 13a receives values to be set for input items from the application service 40.

The display control unit 15 interprets screen information of various screens to display the screens on the display 506.

The receiving unit 16 includes an operation receiving unit 27. The operation receiving unit 27 receives various user operations on the various screens displayed on the display 506.

The input processing unit 14 inputs values transmitted for the input items from the application service 40 to the input fields of the input items. The display control unit 15 performs control to display the screen in which values are set for the respective input items. The input processing unit 14 operates as a result of a program transmitted from the application service 40 being executed by the web browser.

The receiving unit 16 includes the operation receiving unit 27 and an image capturing unit 28. The functions of these units may be substantially the same as the functions illustrated in FIG. 7.

### Application Service

The application service 40 includes a receiving unit 48, a screen generation unit 42, a registration unit 43, an identification unit 44, a program transmission unit 45, an AI control unit 46, a transmission unit 47, and an application information storage unit 49. These functional units of the application service 40 are functions or units implemented as a result of the CPU 501 illustrated in FIG. 6 executing instructions included in one or more programs installed on the application service 40. The application information storage unit 49 is implemented by, for example, the HD 504 or the RAM 503 illustrated in FIG. 6. The application information storage unit 49 is not necessarily included in the application service 40. In some embodiments, the application information storage unit 49 is on a network accessible from the application service 40.

The receiving unit 48 receives a request from a user and the user terminal 10. For example, the receiving unit 48 receives information and an operation for an application. Specifically, the user performs input to the user terminal 10. Thus, the receiving unit 48 receives, from the user terminal 10, information and content of an operation received by the user terminal 10.

The screen generation unit 42 generates the screen information of screens to be displayed by the user terminal 10. The screen information is a program written in HTML, JSON, XML, a script language, CSS, and the like. The screen information may be referred to as a web page. The structure of the web page is specified by HTML, the operation of the web page is defined by the script language, and the style of the web page is specified by the CSS. The user terminal 10 may execute a native application. The native application is an application that becomes executable once the application is installed on the user terminal 10. In the case of the native application, the user terminal 10 holds the configuration of the screens, and information to be displayed is transmitted in the form of JSON, XML, or the like.

The registration unit 43 registers application information in the application information storage unit 49 on an application-by-application basis. The registration unit 43 registers a value corresponding to an input item transmitted from the user terminal 10 or the generative AI system 50 to the application information storage unit 49. The application information includes information set for the input items of the application and information related to the input items of the application. Thus, the application information storage unit 49 stores the information set for the input items of the application and the information related to the input items (see FIGS. 8 and 9).

The identification unit 44 includes an image identification unit 44a, an input item identification unit 44b, and an application identification unit 44c. The image identification unit 44a identifies image data received from the user terminal 10 together with a request for AI-powered input, as extraction-target image data. The input item identification unit 44b receives information for identifying an application from the user terminal 10, and identifies input items of the application based on the information for identifying the application. The application identification unit 44c identifies an application name of the application, based on the information for identifying the application received from the user terminal 10.

The AI control unit 46 transmits and receives a message to and from the generative AI system 50. APIs of the generative AI system 50 are made publicly available. The AI control unit 46 calls an API to transmit a request message including a chat message to the generative AI system 50. The AI control unit 46 receives a response message from the generative AI system 50. As described above, the request message is information including a chat message. The chat message may be referred to as a request message, which is common in HTTP communication.

The AI control unit 46 includes a request generation unit 46a, a request transmission unit 46b, and a response reception unit 46c. The request generation unit 46a generates a request message for calling the API made publicly available by the generative AI system 50. The request message requests the generative AI system 50 to generate information. The request message includes a text portion and image data. The text portion is called a prompt. The image data may be the image data itself or a URL associated with the image data. The request message may further include audio data.

The request transmission unit 46b transmits, to the generative AI system 50, a request including image data and an instruction to extract values corresponding to the input items from the image data. This request is included in the request message generated by the request generation unit 46a.

The response reception unit 46c receives a response message generated by the generative AI system 50 in response to the instruction transmitted to the generative AI system 50. This response message includes the values corresponding to the input items.

The transmission unit 47 transmits the input items and the values for the input items to the user terminal 10. The transmission unit 47 transmits a web application to be executed by the user terminal 10 and screen information used by the web application for displaying screens to the user terminal 10.

In response to a request for a program transmitted from the user terminal 10, the program transmission unit 45 transmits the program to the user terminal 10. This program is a web application, and more specifically, JavaScript® included in the web application, for example.

The information stored in the application information storage unit 49 may be substantially the same as the information illustrated in FIGS. 8 and 9.

### Operations or Processes

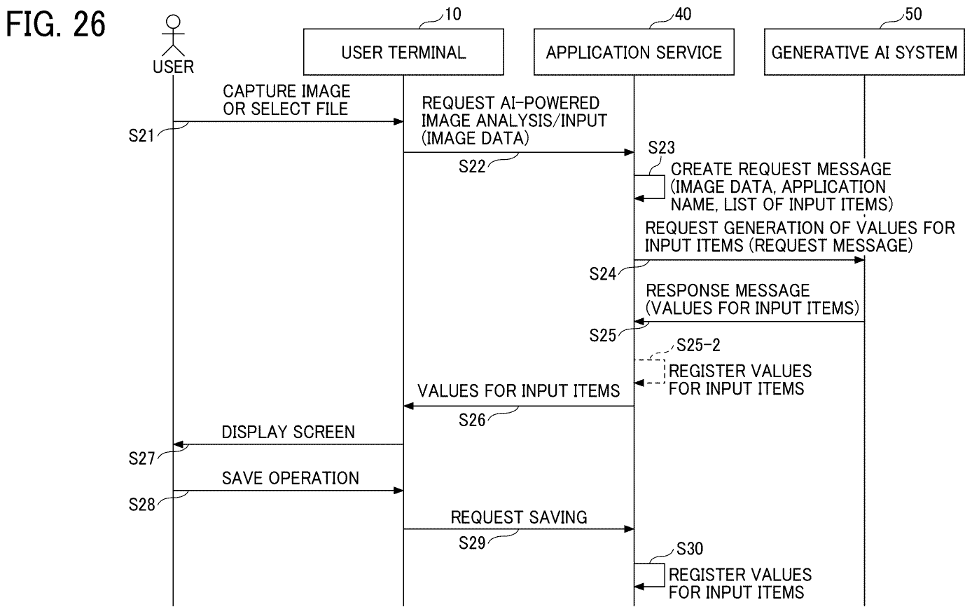

An overall procedure of a process performed by the information processing system 100 will be described with reference to FIG. 26. FIG. 26 is a sequence diagram illustrating the process performed by the information processing system 100. In the description of FIG. 26, differences from FIG. 10 may be described.
S21: The user presses the business card image attachment field 211 illustrated in FIG. 14. Since this allows selection of image capturing or file selection, the user inputs, to the user terminal 10, which method to use to prepare image data of a business card. The operation receiving unit 27 of the user terminal 10 receives the selection. When the user selects image capturing, the image capturing unit 28 controls the camera to generate image data of a business card. When the user selects file selection, the operation receiving unit 27 further receives selection of a file. The business card image attachment field 211 displays the file name of the image data. A thumbnail of the image data may further be displayed.

In the present embodiment, this setting of the image data in the business card image attachment field 211 triggers AI-powered image analysis/input. The AI-powered image analysis/input refers to a processing sequence of analyzing image data to generate a value for an input item and setting the value to the application service 40.
S22: After the AI-powered image analysis/input is started, the transmission unit 13b of the user terminal 10 designates identification information of the application, a record ID of the currently displayed record, namely, information for identifying the record, and the image data of the business card set in the business card image attachment field 211 in a request for AI-powered image analysis/input, and transmits the request to the application service 40. At this time point, the application displayed by the user terminal 10 is identified. Thus, the identification information of the application is known. When a value is set to an application that is not displayed by the user terminal 10, the user selects the application, for example. The record ID of the currently displayed record is identification information of the record currently displayed by the user terminal 10, and thus is known. When the currently displayed record is not registered to the application service 40, the record ID is yet to be assigned. Thus, the user terminal 10 notifies the application service 40 that the record ID is yet to be assigned. The application service 40 assigns a new record ID to the record.
S23: The receiving unit 48 of the application service 40 receives the request for AI-powered image analysis/input. The input item identification unit 44b identifies, in the application information storage unit 49, information related to the input items of the application identified by the identification information of the application, and acquires the list of input items. More specifically, since the label items are appropriate for the input items used by the generative AI system 50, the input item identification unit 44b acquires a list of label items.

The application identification unit 44c acquires the application name of the application identified by the identification information of the application from the application information storage unit 49. The application name is requested because the analysis of the application name by the generative AI system 50 increases the accuracy of generating the appropriate value for the input item. Therefore, the application name may be omitted. The application service 40 may transmit the explanation note of the application to the generative AI system 50 instead of the application name. The explanation note of the application is “This application is an application for managing business cards”, for example.

The image identification unit 44a identifies the image data transmitted from the user terminal 10, as extraction-target image data.

The request generation unit 46a of the application service 40 generates a request message using the application-related information such as the image data of the business card, the application name, and the list of input items. This request message includes an instruction to extract information corresponding to the input items from the image data. FIG. 11 illustrates a description example of this request message.
S24: The request transmission unit 46b transmits a request to generate values for the input items to the generative AI system 50 together with this request message.
S25: The generative AI system 50 analyzes the image data of the business card to generate the values for the input items, and determines correspondences between the values and the input items. The generative AI system 50 transmits a response message to the application service 40. The response message includes the input items and the generated values.
S25-2: The response reception unit 46c of the application service 40 receives the response message including the input items and the generated values. In response to receipt of the response message, the registration unit 43 of the application service 40 may register the generated values for the respective input items in the application information storage unit 49. When the registration unit 43 registers the generated values to the application information storage unit 49, the following processing may be skipped. If the user corrects the generated value, the registered value may be overwritten with the corrected value. In the present embodiment, the case of registering the generated values for the respective input items in step S30, which is after the confirmation of the generated values by the user, will be described.
S26: The transmission unit 47 of the application service 40 transmits the input items and the generated values to the user terminal 10. The reception unit 13a of the user terminal 10 receives the input items and the generated values.
S27: The input processing unit 14 of the user terminal 10 inputs the values corresponding to the input items to the respective input fields of the input items. The display control unit 15 displays the input screen 210 of the business card management application in which the values are set for the input items.

The transmission unit 47 of the application service 40 may transmit screen information for updating the input screen 210 of the business card management application to the user terminal 10, instead of transmitting the input items and the generated values.
S28: The user views the input screen 210 of the business card management application to check the values of the respective input items generated by the generative AI system 50. If any of the generated values is incorrect, the user edits the value on the input screen 210. When saving the values of the respective input items on the input screen 210 of the business card management application, the user performs a save operation on the user terminal 10. The save operation is pressing the save button 219, for example. The operation receiving unit 27 receives the operation.
S29: The transmission unit 13b of the user terminal 10 designates the identification information of the application and the record ID, and transmits a save request to the application service 40 together with the values of the input items and the image data. When the image data has been transmitted, the retransmission may be omitted.
S30: The receiving unit 48 of the application service 40 receives the save request. The registration unit 43 identifies the application based on the identification information of the application, and identifies the record based on the record ID. The registration unit 43 saves or registers the values in association with the respective input items of the identified record in the application information storage unit 49. The transmission unit 47 of the application service 40 transmits “input OK”, which means that the registration of the value is completed, to the user terminal 10. The reception unit 13a of the user terminal 10 receives the “input OK”.

The request message from the user terminal 10 to the generative AI system 50 may be substantially the same as that in FIG. 11. The setting example of the “prompt” 247 may be substantially the same as that in FIG. 12. The response message from the generative AI system 50 to the user terminal 10 may be substantially the same as that in FIG. 13.

An example of the screen transition of the input screen 210 of the business card management application is substantially the same as that in FIGS. 14 and 15. The screen transition according to a modification may be substantially the same as that in FIGS. 18 to 20.

The prompt generated by the request generation unit 21 may be substantially the same as that in FIG. 16. The response message from the generative AI system 50 for the prompt in FIG. 16 may be substantially the same as that in FIG. 17.

Generation of Values using Function Call Capability

In the present embodiment, values for respective input items can also be set using a function call capability provided by the generative AI system 50. In the present embodiment, the application service 40 instead of the user terminal 10 specifies a function and types of arguments of the function for the generative AI system 50. The generative AI system 50 generates the arguments of the function in the specified format. The application service 40 does not have a function to be called. The existence of such a function causes no issues. In the present embodiment, however, since no such function exists, the term “dummy function” is used. Although the term “function call capability” is used, the generative AI system 50 does not call a function of the application service 40. In the present embodiment, the application service 40 specifies a function and types of arguments of the function for the generative AI system 50 using the function call capability in order to acquire the values for the input items in the formats specified by the application service 40 from the generative AI system 50 with increased certainty.

The use of the function call capability can increase the accuracy of the generative AI system 50 returning values in the JSON format as compared to the case where the application service 40 requests the generative AI system 50 to generate the values for the respective input items in the JSON format and the generative AI system 50 generates the values.

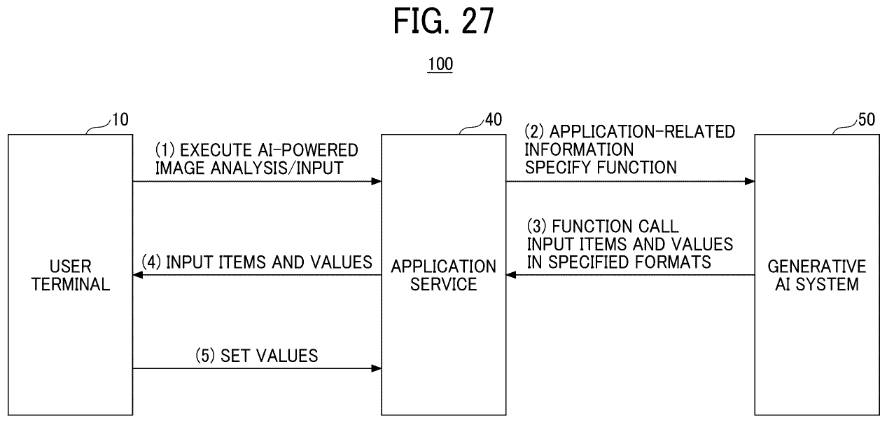

FIG. 27 is a diagram illustrating a method of setting values for input items using the function call capability. In FIG. 27, the user has already set an image data file to the business card image attachment field 211.
(1) After the image data file is set in the business card image attachment field 211, the user terminal 10 transmits a request to execute the AI-powered image analysis/input to the application service 40.
(2) In response to receipt of the request to execute the AI-powered image analysis/input, the application service 40 includes types of arguments of a function in a request message and transmits the request message to the generative AI system 50. The function is a program interface that performs a preset process with a specified argument and returns a return value as a result. In the present embodiment, however, the application service 40 does not have a function. The application service 40 includes formats of arguments of a function, namely, a dummy function, in a request message, and transmits the request message to the generative AI system 50. Consequently, it is expected that the function call from the generative AI system 50 includes the values for the respective input items in the format specified by the application service 40.

The generative AI system 50 requesting the application service 40 to call the dummy function that does not actually exist is called “function call”, namely, tool_call in the present embodiment.

If the application service 40 actually has the function, this does not cause any issues. The application service 40 may execute the function to set the values to the application service 40. Executing a function includes transmitting input items and values to the user terminal 10 and setting the values associated with the respective input items received from the user terminal 10 to the application service 40.

In some embodiments, the application service 40 does not include the formats of the arguments of the function in the same request message as the request message including the application-related information. For example, the application service 40 may include the formats of the arguments of the function in another request message different from the request message including the application-related information and transmit the request messages to the generative AI system 50.
(3) Based on the application-related information and the formats of the arguments of the function included in the transmitted request message(s), the generative AI system 50 transmits a response message including the function call (tool_call) to the application service 40. The expression “the generative AI system 50 requests the application service 40 to call a function” does not indicate that the generative AI system 50 requests execution of the function but just proposes values for the input items in the specified format.

That is, the generative AI system 50 includes the input items and the respective values of the application transmitted from the application service 40 in a response message as arguments of the function. These values are generated through analysis of the application-related information.
(4) The application service 40 receives the response message from the generative AI system 50, acquires the input items and the respective values included in the function call (tool_call) included in the response message, and transmits the input items and the respective values to the user terminal 10.
(5) The user terminal 10 receives the input items and the respective values. The user checks the values and presses the save button 219. The user terminal 10 then requests the application service 40 to set the values for the respective input items. The application service 40 saves the received values associated with the respective input items in the application information storage unit 49.

The request message from the application service 40 to the generative AI system 50 may be substantially the same as that in FIG. 22. The response message from the generative AI system 50 to the user terminal 10 may be substantially the same as that in FIG. 23.

According to the present embodiment, the information processing system 100 can automatically set, for input items, respective values obtained by the generative AI system 50 through analysis of image data in response to the user setting the image data including values for the input items in the business card image attachment field 211. The user terminal 10 can set appropriate values extracted from the image data, for the respective input items of any application as well as a single application.

### Third Embodiment

In the present embodiment, modifications common to the first and second embodiments will be described.

### Selection of Image Data for Use in AI-Powered Image Analysis/Input

One record of an application may have a plurality of pieces of image data. For example, the business card management application may have the business card image attachment field and a face image attachment field. The image data set in the face image attachment field represents a face image of a client, and thus does not include a value of the input item. In this case, when the generative AI system 50 analyzes the face image of the client, cost increases in terms of time and processing load.

When the generative AI system 50 is of a pay-per-use type, the analysis of the face image of the client incurs extra cost.

Accordingly, it is effective to allow the user to select image data for use in AI-powered image analysis/input on the input screen 210 of the business card management application.

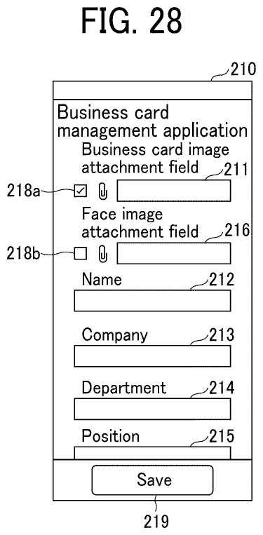

FIG. 28 illustrates an input screen 230 of the business card management application displayed by the user terminal 10. When the business card management application has input items of a business card image and a face image, the input screen 230 of the business card management application includes a face image attachment field 216 in addition to the business card image attachment field 211. The input screen 230 of the business card management application includes a checkbox 218a for selecting the business card image attachment field 211 and a checkbox 218b for selecting the face image attachment field 216. The user desires to cause the generative AI system 50 to analyze image data set in the business card image attachment field 211. Thus, the user selects the checkbox 218a for the business card image attachment field 211.

Consequently, the request message generated by the request generation unit 21 in step S6 in FIG. 10 includes only the image data set in the business card image attachment field 211 for which the checkbox 218a is checked. Thus, the content of the prompt is the same as that in FIG. 16.

### Request Message With Designated Input Range of Value

Some input items of the application may have an input range. For example, an input item with the data format of the character string may have the maximum and minimum numbers of characters that can be input. An input item whose value is the numerical value may have the maximum and minimum values that can be input.

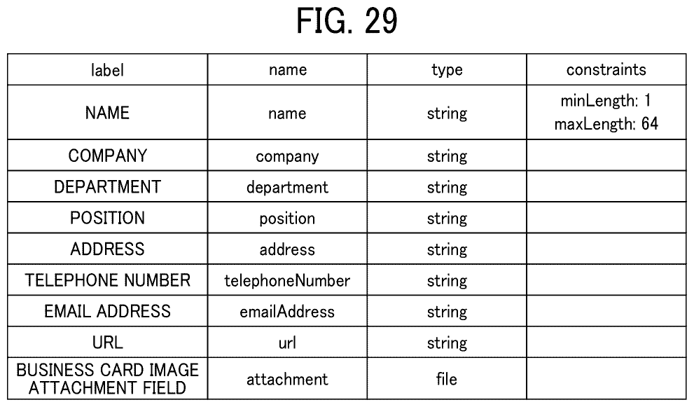

FIG. 29 illustrates information related to an input item having an input range. As compared with FIG. 9, FIG. 29 further illustrates a constraints item. The constraints item defines an input range of the value of an input item. For example, the input range whose minimum number of characters (minLength) is 1 and maximum number of characters (maxLength) is 64 is set for the input item with the label item “name”.

When generating a prompt, the request generation unit 21 includes information on the input range in the prompt. This can prevent the value generated by the generative AI system 50 from being outside the input range of the application.

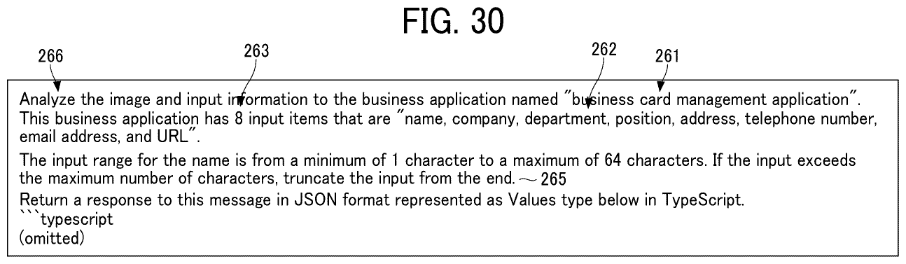

FIG. 30 illustrates an example of a prompt for requesting values for the input items in the JSON format without using the function call. In FIG. 30, differences from FIG. 16 will be described. The prompt illustrated in FIG. 30 additionally includes text data 265, which is “The input range for the name is from a minimum of 1 character to a maximum of 64 characters. If the input exceeds the maximum number of characters, truncate the input from the end.”. “1” and “64” in the text data 265 are changed in accordance with the constraints item of the information related to the input items illustrated in FIG. 29.

That is, as indicated below, ${ . . . } for the maximum number of characters and the minimum number of characters are additionally set in the template illustrated in FIG. 12. “The input range for the name is from a minimum of ${minLength} character to a maximum of ${maxLength} characters. If the input exceeds the maximum number of characters, truncate the input from the end.” The request generation unit 21 replaces the ${minLength} with “1” and the ${maxLength} with “64”. Thus, the text data 265 other than “1” and “64” is fixed.

The generative AI system 50 analyzes the text data 265 included in the prompt, and generates the value for the “name” so that the value is not outside the input range.

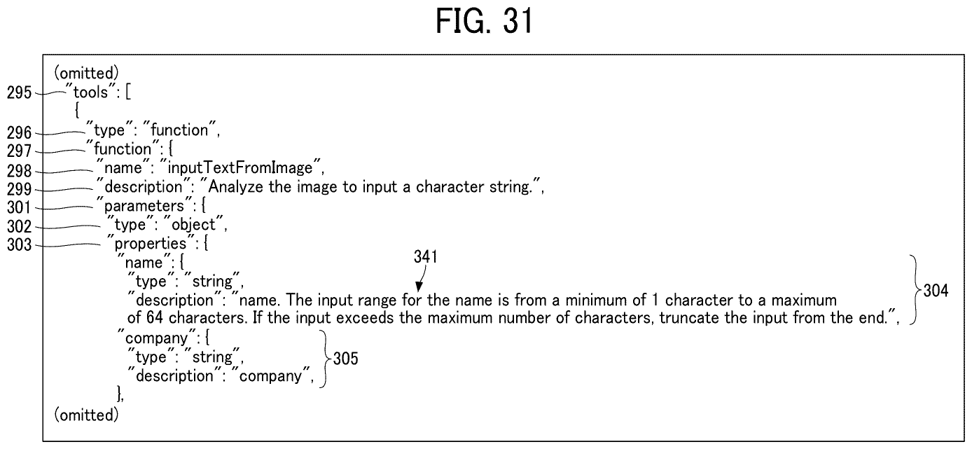

FIG. 31 illustrates an example of a request message when the generative AI system 50 has the function call capability. In the description of FIG. 31, differences from FIG. 22 will be described. In FIG. 31, text data 341 is added to the “name” 304.

The text data 341 is “The input range for the name is from a minimum of 1 character to a maximum of 64 characters. If the input exceeds the maximum number of characters, truncate the input from the end.” The text data 341 specifies the presence of the input range for the “name” and processing to be performed when the value is outside the input range.

The generative AI system 50 analyzes the description related to the arguments of the function, and generates the value so that the value to be generated for the input item “name” is not outside the input range. The description includes the presence of the input range and the processing to be performed when the value is outside the input range.

In addition to the input range, the data format of the date (e.g., “Month Day, Year” or MM/DD/YYYY), the data format of the time (e.g., hhmmss), the data format of the telephone number (e.g., presence or absence of hyphens), the data format of the facsimile number (e.g., presence or absence of hyphens), the data format of the postal code (e.g., presence or absence of hyphens), the data format of the address (e.g., presence or absence of hyphens in details below the block number), or the data format of the email address (e.g., containing a single @ symbol), for example, may be defined.

This can prevent the value generated by the generative AI system 50 from being outside the input range of the application.

### Few-Shot Prompting

There is a technique called few-shot prompting for increasing the accuracy of the generation of a value by providing the generative AI system 50 with some output examples in the prompt. In the present embodiment, few-shot prompting can increase the accuracy of the generation of the value for the input item.

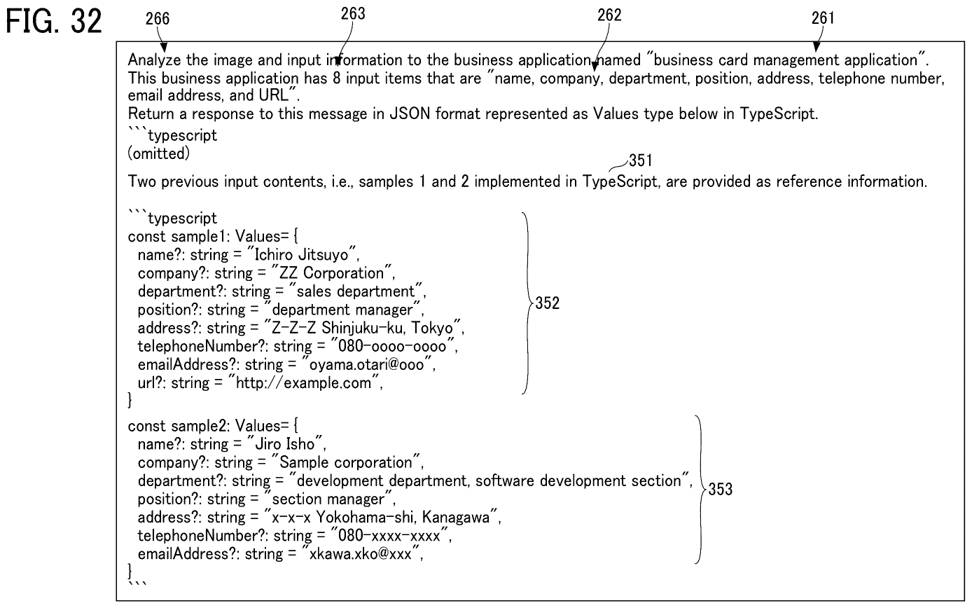

FIG. 32 illustrates a prompt using few-shot prompting. Few-shot prompting is a technique involving the inclusion of one or more output examples in the prompt. Thus, the request generation unit 21 includes, in the prompt, the information (FIG. 8) that has been registered in the application service 40. In FIG. 32, differences from FIG. 16 will be described.

A message 351 is that “Two previous input contents, i.e., sample1 and sample2 implemented in TypeScript, are provided as reference information.” and indicates that the following is the information that has been registered in the application and the information is desirably used as reference.

“const sample1” 352 indicates the first input content. In the “const sample1” 352, values of one record of the information already registered in the application are written in association with the respective name items, which are information related to the input items.

“const sample2” 353 indicates the second input content. In the “const sample2” 353, values of one record of the information already registered in the application are written in association with the respective name items, which are information related to the input items.

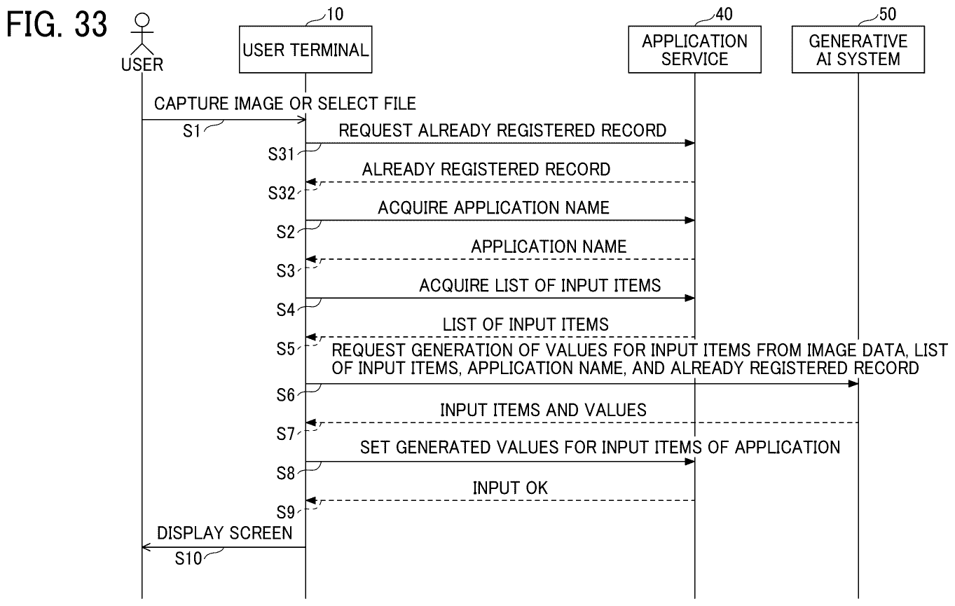

FIG. 33 is a sequence diagram illustrating a process performed by the information processing system 100 when few-shot prompting is used. In FIG. 33, differences from FIG. 10 according to the first embodiment will be described. In FIG. 33, steps S31 and S32 are added. Part of the processing in steps S6 and S7 is also changed.
S31: The request generation unit 21 of the user terminal 10 designates the identification information of the application, and requests the application service 40 to provide one or more records of information registered to the application in the past.
S32: The receiving unit 48 of the application service 40 receives the request. The registration unit 43 acquires one or more records of the information registered to the application from the application information storage unit 49. The transmission unit 47 transmits the one or more records to the user terminal 10.
S6: The request generation unit 21 of the user terminal 10 generates a request message including the image data of the business card, the application name, the list of input items, and one or more records. The input processing unit 14 transmits the request message to the generative AI system 50.
S7: The generative AI system 50 analyzes the image data of the business card and generates values from the image data with reference to the one or more records. The generative AI system 50 determines correspondences between the generated values and the respective input items. The generative AI system 50 transmits a response message including the input items and the corresponding values to the user terminal 10. The reception unit 13a of the user terminal 10 receives the input items and the corresponding values.

The subsequent processing may be similar to that in FIG. 10.

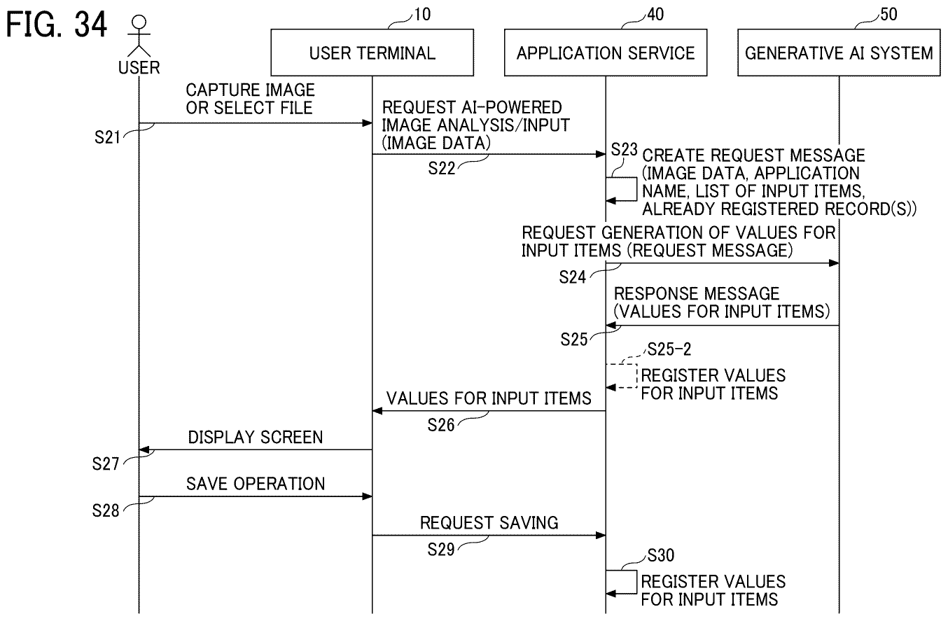

FIG. 34 is a sequence diagram illustrating a process performed by the information processing system 100 when few-shot prompting is used. In FIG. 34, differences from FIG. 26 according to the second embodiment will be described. In FIG. 34, processing in steps S23 and S25 is different from that in FIG. 26.
S23: The receiving unit 48 of the application service 40 receives a request for AI-powered image analysis/input. The method for identifying the list of input items, the application name, and the image data may be the same as that in FIG. 26. The application identification unit 44c identifies one or more already registered records of the application, for example, the business card management application, executed by the user terminal 10, from the application information identified by the identification information of the application.

The request generation unit 46a of the application service 40 generates a request message using the application-related information such as the image data of the business card, the application name, and the list of input items and the already registered records. This request message includes an instruction to extract information corresponding to the input items from the image data.
S24: The request transmission unit 46b transmits a request to generate values for the input items to the generative AI system 50 together with this request message.
S25: The generative AI system 50 analyzes the image data to generate the values from the image data, and determines correspondences between the input items and the values generated with reference to the one or more records. The generative AI system 50 transmits a response message to the application service 40. The response message includes the input items and the generated values.

The subsequent processing may be similar to that in FIG. 26.

Few-shot prompting makes it easier for the generative AI system 50 to determine the value to be associated with each input item and can increase the accuracy of the generation of the values. This makes it easier for the user terminal 10 to acquire the value corresponding to each input item.

Few-shot prompting can increase the accuracy of the generation of the generated value of the input item.

### Analysis of File Other Than Image Data

The generative AI system 50 can analyze a file in a format of document data, video data, or audio data other than text data and image data. In the present embodiment, to generate values for the respective input items, the user terminal 10 can transmit the document data, the video data, and the audio data similarly to the image data to the generative AI system 50.

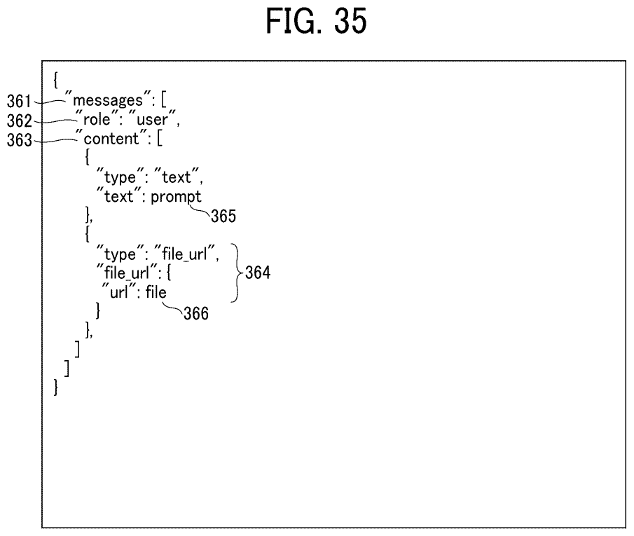

FIG. 35 is a diagram illustrating a request message transmitted by the user terminal 10 to the generative AI system 50. In the description of FIG. 35, differences from FIG. 11 will be described. “messages” 361, “role” 362, and “content” 363 are substantially the same as the “messages” 241, the “role” 242, and the “content” 243 in FIG. 11, respectively. Each parameter has a set of “type” and a value. In a parameter 364, “file_url” is newly specified as the “type”.

When the “type” is “file_url”, the value of the “url” is “file” 366. In the “file” 366, a URL where the file is saved or a file encoded by Base64 is input.

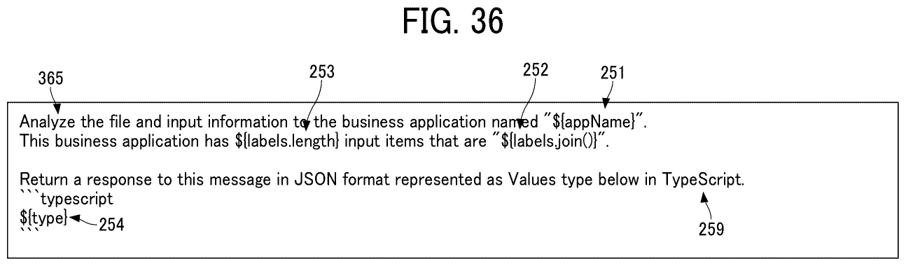

FIG. 36 illustrates an example of a character string set in a “prompt” 365 in FIG. 35. In FIG. 36, differences from FIG. 12 will be described. In FIG. 36, the text in the beginning part in FIG. 12 is changed from “image” to “file” 365. The generative AI system 50 understands the instruction to recognize the “file 365” during the analysis of the prompt. The generative AI system 50 analyzes the “file” included in the request message to determine to generate values for the respective input items of the business card management application.

As described above, the request generation unit 21 changes the description of the prompt, so that the format of the data to be analyzed by the generative AI system 50 can be changed. For example, in the case of video data, even when an image of a business card is captured as a video, the generative AI system 50 can generate values for the input items. In the case of document data, even when a memo or a form includes the name, the generative AI system 50 can generate values for the input items. In the case of audio data, even when a conversation includes the name, the generative AI system 50 can generate values for the input items.

The prompt allows a plurality of files to be designated. Thus, the request generation unit 21 may include two or more of image data, document data, video data, and audio data in a single prompt, and transmit the prompt to the generative AI system 50. In this case, the “file” 365 is changed to “Analyze the image, document, video, and audio”.

This allows the generative AI system 50 to analyze a file of text data or image data and generate values for input items.

As described above, an information processing system according to the present disclosure can extract information from image data without preparing a logic for extracting information from image data in advance.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, the user terminal 10 or the application service 40 transmits the image data to the generative AI system 50. In some embodiments, the image data may be saved in a predetermined server. In this case, the application service 40 transmits information for designating the image data in the server to the generative AI system 50. The generative AI system 50 acquires the image data from the server and generates values of the input items.

In the present embodiment, the JSON format is used to represent the values for the input items generated by the user terminal 10 or the generative AI system 50. Alternatively, the values of the input items may be represented in another format such as XML or comma-separated values (CSV).

In the present embodiment, the user terminal 10 sets the generated values for the input items of the application managed by the application service 40. Alternatively, the user terminal 10 may set the generated values for the input items of a native application that operates on the user terminal 10. For example, when the user terminal 10 executes a spreadsheet application, the user terminal 10 may set the generated values to cells of the spreadsheet application.

The apparatuses or devices described in one or more embodiments are merely examples of computing environments that can implement the embodiments disclosed herein. In one embodiment, the application service 40 includes multiple computing devices such as a server cluster. The multiple computing devices communicate with one another through any type of communication link including a network, shared memory, or the like and perform the processes disclosed herein.

The application service 40 may share the processing steps disclosed in the embodiments of the present disclosure, for example, steps of FIG. 10 or the like in various combinations. For example, a process executed by a predetermined unit may be executed by multiple information processing apparatuses included in the application service 40. The application service 40 may be integrated into one server apparatus or may be divided into a plurality of devices.

In the configuration examples illustrated in FIG. 7 and the like, the application service 40 is divided according to the functions of the application service 40 to facilitate understanding of the processes performed by the application service 40. No limitation on the present disclosure is intended by how the functions are divided by process or by the name of the functions. The processes performed by the application service 40 may be divided into more processing units in accordance with the content of the processing. The division may be performed so that one processing unit includes more processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Embodiments of the present disclosure greatly enhance the performance and the functionality of computers. Such enhancement allows users to take advantage of the computers that provide more efficient and robust interaction with tables that are a way to store and present information on information processing apparatuses. Embodiments of the present disclosure provide a better user experience through the use of a more efficient, powerful and robust user interface. Such a user interface provides a better interaction between a human and a machine.

### Aspects

According to Aspect 1, an information processing apparatus that is communicable with a server apparatus and a generative AI system includes a receiving unit, a request transmission unit, a response reception unit, and a transmission unit. The receiving unit receives input of an image from which information to be registered in the server apparatus is extracted. The request transmission unit transmits, to the generative AI system, the image and a request to extract information from the image. The information corresponds to an item set in advance. The response reception unit receives, from the generative AI system, the information corresponding to the item and extracted from the image by the generative AI system. The transmission unit transmits, to the server apparatus, the information corresponding to the item to register the information in the server apparatus.

According to Aspect 2, the information processing apparatus of Aspect 1 further includes a display control unit. The display control unit causes a display to display a screen on which the information received by the response reception unit and the item are displayed in association with each other and an instruction to register the information in the server apparatus is receivable. When the instruction is received via the screen, the transmission unit transmits the information corresponding to the item to the server apparatus to register the information in the server apparatus.

According to Aspect 3, in the information processing apparatus of Aspect 2, the display control unit causes a plurality of records registered in the server apparatus to be displayed, the receiving unit receives, from a user, selection of a record from among the plurality of records, and the response reception unit receives the information corresponding to an item set in the selected record.

According to Aspect 4, the information processing apparatus of Aspect 1 further includes a display control unit and an operation receiving unit. The display control unit causes a display to display a setting screen for setting an item included in a record registered in the server apparatus. The operation receiving unit receives, on the setting screen, a setting of the item included in the record.

According to Aspect 5, in the information processing apparatus of Aspect 4, the operation receiving unit receives a setting of an item name of the item, and the transmission unit transmits the image and the set item name of the item to the server apparatus.

According to Aspect 6, in the information processing apparatus of Aspect 2, the display control unit displays the information on the screen in an editable manner when the information is displayed in association with the item.

According to Aspect 7, in the information processing apparatus of any one of Aspects 2 to 6, when the receiving unit receives the instruction to register the information from a user, the transmission unit transmits the information displayed on the screen to the server apparatus.

According to Aspect 8, the information processing apparatus of any one of Aspects 1 to 6 further includes an operation receiving unit. The operation receiving unit receives an instruction from a user. The receiving unit calls an image capturing device in response to the instruction received from the user by the operation receiving unit. The receiving unit receives input of an image captured by the image capturing device.

According to Aspect 9, the information processing apparatus of any one of Aspects 1 to 6 further includes a display control unit and an operation receiving unit. The display control unit causes a list of images stored in a memory to be displayed. The list of images includes the image. The operation receiving unit receives, from a user, selection of the image from the list of images. The receiving unit receives input of the image for which the selection is received by the operation receiving unit.

According to Aspect 10, a program causes an information processing apparatus that is communicable with a server apparatus and a generative AI system to function as: a receiving unit configured to receive input of an image from which information to be registered in the server apparatus is extracted; a request transmission unit configured to transmit, to the generative AI system, the image and a request to extract information from the image, the information corresponding to an item set in advance; a response reception unit configured to receive, from the generative AI system, the information corresponding to the item and extracted from the image by the generative AI system; and a transmission unit configured to transmit, to the server apparatus, the information corresponding to the item to register the information in the server apparatus.

According to Aspect 11, a program causes a server apparatus that is communicable with an information processing apparatus and a generative AI system to function as: a receiving unit configured to receive input of an image from which information to be registered in the server apparatus is extracted; a request transmission unit configured to transmit, to the generative AI system, the image and a request to extract information from the image, the information corresponding to an item set in advance; a response reception unit configured to receive, from the generative AI system, the information corresponding to the item and extracted from the image by the generative AI system; and a registration unit configured to register the received information in association with the item.

According to Aspect 12, an information processing method is to be performed by a server apparatus that is communicable with an information processing apparatus and a generative AI system. The information processing method includes: receiving input of an image from which information to be registered in the server apparatus is extracted; transmitting, to the generative AI system, the image and a request to extract information from the image, the information corresponding to an item set in advance; receiving, from the generative AI system, the information corresponding to the item and extracted from the image by the generative AI system; and registering the received information in association with the item.

1. An information processing apparatus communicably connected to a server apparatus and a generative AI system, the information processing apparatus comprising circuitry configured to:
receive input of an image from which information to be registered in the server apparatus is extracted;
transmit, to the generative AI system, the image and a request to extract information from the image, the information corresponding to an item set in advance;
receive, from the generative AI system, the information corresponding to the item and extracted from the image by the generative AI system; and
transmit, to the server apparatus, the information corresponding to the item to register the information in the server apparatus.

2. The information processing apparatus according to claim 1, wherein the circuitry is configured to:
display, on a display, a screen for displaying the received information and the item in association and for receiving an instruction to register the information in the server apparatus; and
in response to receiving the instruction via the screen, transmit the information corresponding to the item to the server apparatus to register the information in the server apparatus.

3. The information processing apparatus according to claim 2, wherein the circuitry is configured to:
display, on the display, a plurality of records registered in the server apparatus;
receive, from a user, selection of a record from among the plurality of records; and
receive the information corresponding to an item set in the selected record.

4. The information processing apparatus according to claim 1, wherein the circuitry is configured to:
display, on the display, a setting screen for setting an item included in a record registered in the server apparatus; and
receive, on the setting screen, a setting of the item included in the record.

5. The information processing apparatus according to claim 4, wherein the circuitry is configured to:
receive a setting of an item name of the item; and
transmit the image and the set item name of the item to the server apparatus.

6. The information processing apparatus according to claim 2, wherein the circuitry is configured to display the information on the screen in an editable manner when the information is displayed in association with the item.

7. The information processing apparatus according to claim 2, wherein the circuitry is configured to, in response to receiving the instruction to register the information from a user, transmit the information displayed on the screen to the server apparatus.

8. The information processing apparatus according to claim 1, wherein the circuitry is configured to:
call an image capturing device in response to an instruction received from a user; and
receive input of an image captured by the image capturing device.

9. The information processing apparatus according to claim 1, wherein the circuitry is configured to:
display, on a display, a list of images stored in a memory, the list of images including the image;
receive, from a user, selection of the image from the list of images; and
receive input of the image for which the selection is received.

10. A system comprising:
an information processing apparatus; and
a server apparatus communicably connected to the information processing apparatus and a generative AI system,
the information processing apparatus including apparatus circuitry configured to:
receive input of an image from which information to be registered in the server apparatus is extracted;
transmit, to the generative AI system, the image and a request to extract information from the image, the information corresponding to an item set in advance;
receive, from the generative AI system, the information corresponding to the item and extracted from the image by the generative AI system; and
transmit the information corresponding to the item to the server apparatus to register the information in the server apparatus,
the server apparatus including server circuitry configured to:
receive input of an image from which information to be registered in the server apparatus is extracted;
transmit, to the generative AI system, the image and a request to extract information from the image, the information corresponding to an item set in advance;
receive, from the generative AI system, the information corresponding to the item and extracted from the image by the generative AI system; and
register the received information in association with the item.

11. An information processing method performed by an information processing apparatus communicably connected to a server apparatus and a generative AI system, the information processing method comprising:
receiving input of an image from which information to be registered in the server apparatus is extracted;
transmitting, to the generative AI system, the image and a request to extract information from the image, the information corresponding to an item set in advance;
receiving, from the generative AI system, the information corresponding to the item and extracted from the image by the generative AI system; and
transmitting the information corresponding to the item to the server apparatus to register the information in the server apparatus.
